(19) United States
(12) Patent Application Publication
(10) Pub. No.: US 2024/0126975 A1
(43) Pub. Date: Apr. 18, 2024

(54) METHOD, APPARATUS, TERMINAL AND STORAGE MEDIUM FOR DATA PROCESSING FOR AN APPLICATION

(71) Applicant: Beijing Zitiao Network Technology Co., Ltd., Beijing (CN)

(72) Inventors: Changming Wang, Beijing (CN); Fan Yang, Beijing (CN); Linna Zhang, Beijing (CN); Bingxi Lin, Beijing (CN); Changyu Guo, Beijing (CN); Fang Liu, Beijing (CN); Zisheng Liu, Beijing (CN); Tian Lan, Beijing (CN); Fabin Liu, Beijing (CN); Zhengzhe Zhang, Beijing (CN); Siyu Hou, Beijing (CN); Yao Wang, Beijing (CN)

(21) Appl. No.: 18/396,647

(22) Filed: Dec. 26, 2023

Related U.S. Application Data
(63) Continuation of application No. PCT/CN2022/113093, filed on Aug. 17, 2022.

(30) Foreign Application Priority Data
Aug. 18, 2021 (CN) 202110950234.2
Sep. 7, 2021 (CN) 202111046169.7

(51) Int. Cl. G06F 40/106; G06F 16/93; G06F 40/123

(52) U.S. Cl. CPC G06F 40/106; G06F 16/93; G06F 40/123

(57) ABSTRACT

A method of data processing for an application includes displaying service data in a first display area of a first application display interface; displaying first online document information in a second display area of a first application display interface, the first online document carrying a file required for processing the service data; and processing the service data in response to a first operation initiated based on the content carried by the first online document. The method of data processing for an application displays business data and the first online document in the first display area and the second display area respectively, and operates the business data based on the first operation initiated by the content carried by the first online document, so that the processing method of business data is associated with the content carried by the first online document, thereby improving the flexibility and convenience of business data processing.

### CROSS REFERENCE

The present application is a continuation of International Patent Application No. PCT/CN2022/113093, filed on Aug. 17, 2022, which claims priorities to Chinese Patent Application No. 202111046169.7 filed on Sep. 7, 2021, entitled “method, apparatus, terminal and storage medium for data processing for an application”, and the Chinese Patent Application No. 202110950234.2 filed on Aug. 18, 2021, entitled “method, apparatus, terminal and storage medium for data processing for an application”, all of which are incorporated herein by reference in their entireties.

### FIELD

The present disclosure relates to the technical field of data processing, and more specifically, to a method, apparatus, terminal and storage medium for data processing for application.

### BACKGROUND

When processing corresponding service data in an application, it is often necessary to refer to some content or files. How to handle these contents or files, such as how to display and load them, to improve the efficiency of information processing in these scenarios, is a problem that needs to be solved.

### SUMMARY

To solve the existing problems, the present disclosure provides an application data processing method, apparatus, terminal and storage medium.

This disclosure adopts the following technical solution.

In some embodiments, the present disclosure provides a method for data processing based on application, comprising: displaying service data in a first display area of a first application display interface; displaying first online document information in a second display area of the first application display interface, the first online document carrying content required for processing the service data; and processing the service data in response to a first operation initiated based on the content carried by the first online document.

In some embodiments, the present disclosure provides a data processing apparatus for an application, comprising: a display unit configured to display service data in a first display area of a first application display interface and to display first online document information in a second display area of the first application display interface, the first online document carrying content required for processing the service data; and a processing unit configured to process the service data in response to a first operation initiated based on the content carried by the first online document.

In some embodiments, the present disclosure provides a terminal comprising: at least one memory and at least one processor. The memory is configured to store program code, and the processor is configured to call the program code stored in the memory to execute the above method.

In some embodiments, the present disclosure provides a computer-readable storage medium storing program code, the program code, when executed by a processor causes the processor to perform the method according to the above method.

According to the data processing method for an application as provided in the present disclosure, service data and a first online document are respectively displayed in the first display area and the second display area display. Based on the first operation of the content carried by the first online document initiated, the service data is operated. As such, the processing mode of the service data is associated with the content carried by the first online document, thereby improving the flexibility and convenience of service data processing.

### BRIEF DESCRIPTION OF THE DRAWINGS

In conjunction with the accompanying drawings and with reference to the following detailed description, the above and other features, advantages and aspects of the various embodiments of the present disclosure will become more apparent. Throughout the drawings, like or similar reference numerals denote like or similar elements. It should be understood that the drawings are illustrative and that elements and elements are not necessarily drawn to scale.

FIG. 1 is a flowchart of a method of data processing for an application of the present disclosure embodiment.

FIG. 2 is a schematic view of an item template of the present embodiment of the disclosure.

FIG. 3 is a schematic view of an item template of the present embodiment of the disclosure.

FIG. 4 is a schematic display of a first processing item of the present embodiment of the disclosure.

FIG. 5 is a flowchart of a method of information processing of the present embodiment of the disclosure.

FIG. 6 is a schematic display of a target communication program of the present embodiment of the disclosure.

FIG. 7 is a schematic display of a target communication program of the present embodiment of the disclosure.

FIG. 8 is a schematic diagram of a change in the document display area of the present embodiment of the disclosure.

FIG. 9 is a first embodiment of the present disclosure processing items in a first online document non-full screen and full screen display diagram.

FIG. 10 is a schematic diagram of an apparatus for information processing of the present disclosure embodiment.

FIG. 11 is a flowchart of a method for information processing according to an embodiment of the present disclosure.

FIG. 12 is a flow chart of the approval process and the filing process of the related art.

FIG. 13 is a flowchart of an approval filing process according to an embodiment of the present disclosure.

FIG. 14 is a schematic diagram of an apparatus for information processing according to an embodiment of the present disclosure.

FIG. 15 is a flowchart of a method of information processing of the embodiment of the present disclosure.

FIG. 16 shows a schematic diagram of a process flow according to some embodiments.

FIG. 17 shows a schematic diagram of the flow design according to some embodiments.

FIG. 18 and FIG. 19 shows a schematic diagram of a notification message according to some embodiments.

FIG. 20 is a partial module for an apparatus for information processing of some embodiments of the present disclosure.

FIG. 21 is a schematic structural diagram of an electronic device of the present embodiment of the disclosure.

### DETAILED DESCRIPTION

The following embodiments of the present disclosure will be described in more detail with reference to the accompanying drawings. Although certain embodiments of the present disclosure are shown in the drawings, it should be understood that the present disclosure can be implemented in various forms and should not be construed as limited to the embodiments set forth herein. On the contrary, these embodiments are provided for a more thorough and complete understanding of the present disclosure. It should be understood that the drawings and embodiments of the present disclosure are for illustrative purposes only and are not intended to limit the scope of the present disclosure.

It should be understood that the various steps described in the method implementation method of this disclosure can be executed in parallel. In addition, the method implementation method can include additional steps and/or omit the steps shown. The scope of this disclosure is not limited in this regard.

The term “including” and its variations used in this article are open-ended, i.e. “including but not limited to”. The term “based on” means “at least partially based on”. The term “one embodiment” means “at least one embodiment”; the term “another embodiment” means “at least one additional embodiment”; and the term “some embodiments” means “at least some embodiments”. Relevant definitions of other terms will be given in the following description.

It should be noted that the concepts of “first” and “second” mentioned in this disclosure are only used to distinguish different devices, modules, or units, and are not used to limit the order or interdependence of the functions performed by these devices, modules, or units.

It should be noted that the modification of “one” mentioned in this disclosure is illustrative and not restrictive. Those skilled in the art should understand it as “one or more” unless otherwise specified in the context.

The names of the messages or information exchanged between multiple devices in this public implementation are for illustrative purposes only and are not intended to limit the scope of these messages or information.

The form of the online document disclosed in this disclosure is not limited, for example, it can be a text document, a table document, a multimedia document, etc. The application includes a series of instructions and/or data collections running on electronic devices such as personal computers (PCs), mobile terminals, virtual reality (VR) devices, and enhanced display (AR) devices, which are used to provide specific services or perform predetermined data processing. The series of instructions and/or data collections on the device are used to provide specific services or perform predetermined data processing.

The following in conjunction with the accompanying drawings, the embodiments of the present disclosure provide a detailed description.

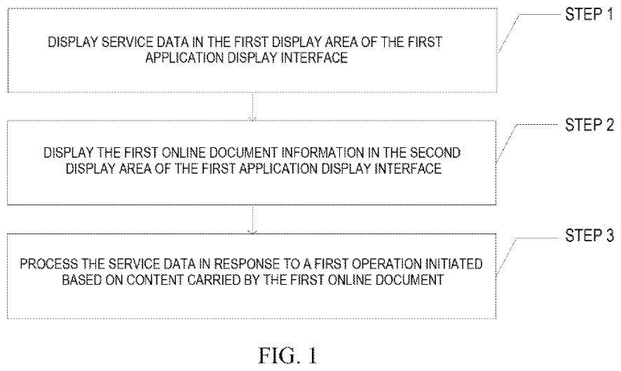

As shown in FIG. 1, some embodiments propose data processing methods for applications, including:

Step 1: display service data in the first display area of the first application display interface.

Specifically, the first application can be associated with the first service logic, and the first application can process the service data of the first application according to the first service logic. Specifically, the first service logic can include one or more of the order, processing flow, and processing methods set in the first application for processing the service data of the first application. The service data can be the service data of the first application.

Step 2: display the first online document information in the second display area of the first application display interface, and the first online document is used to carry the content required for processing the service data.

In some embodiments, the first online document may be an online document associated with the first application, such as an online document associated with service data of the first application. The display interface of the first application has a first display area and a second display area which display service data and the first online document, respectively, so that the first online document can be referred to when processing the first service data, and the convenience and diffusion ability of the online document can be utilized to make the processing of service data more convenient. In some embodiments of the present disclosure, the second display area can present the content of the first online document and can browse the content of the first online document according to the operation. The size of the document display area may not present all the content of the first online document at once, so the content of the first online document can be browsed according to the operation, making it convenient for users to view the first online document as needed. The content of the first online document can be the content data carried by the first online document.

Step 3: process the service data in response to a first operation initiated based on the content carried by the first online document.

In some embodiments, the content carried by the first online document can be data related to the promotion of service data, such as content that needs to be referenced or relied upon for processing service data. In the present disclosure, the first operation is performed based on the content carried by the first online document, and the service data is processed, so that the processing of service data is associated with the content carried by the first online document, thereby improving the convenience of service data processing.

In some embodiments of the present disclosure, displaying the first online document information includes: adding an existing first online document in response to the online document adding control being triggered, or creating a first online document. In some embodiments, the online document adding control can be displayed in the first application and can be used to add an online document instead of a local document after the control is triggered. Compared with adding a local document, using the online document can reduce the storage space requirements and facilitate user collaboration and processing. In other embodiments of the present disclosure, the first online document can be created in the display interface of the first application, and the created first online document can be associated with the first application. The first online document can be a text document, a table document, a picture document, or a hybrid document.

In some embodiments of the present disclosure, further comprising: in response to a second operation, adding a file required for processing the service data to the first online document. In some embodiments of the present disclosure, files can also be added to the first online document, and the added file can be a local file or an online file, and files can be added in a linked manner. By adding files required for processing service data in the first online document, data that needs to be referred to when processing service data can be summarized into the first online document, thereby improving the degree of aggregation of information, eliminating the need to refer to other data, reducing user operations, and improving convenience.

In some embodiments of the present disclosure, displaying the first online document information in the second display area of the first application display interface comprises: displaying the first online document in an unfolded state in the second display area to display the content information carried by the first online document. In some embodiments, the unfolded state refers to a state in which the content information carried by the first online document can be displayed, which is different from a folded state. In the unfolded state, at least part of the content information carried by the first online document can be seen, that is, the specific content recorded in the first online document can be seen. In the folded state, the content information carried by the first online document can be displayed without displaying the abbreviated information of the first online document.

In some embodiments of the present disclosure, the file required to process the service data by the first online document bearer, the application processing interface does not include an attachment addition control other than the online document. In some embodiments of the present disclosure, the file required for processing the service data can be carried by the first online document, and the file required for processing the service data cannot be displayed in other areas, so the user can only check the relevant files in the first online document, so there is no need to display the attachment addition control other than the online document addition control in the application processing interface.

In some embodiments of the present disclosure, further comprising: associating the first online document with the document archive address to achieve automatic archiving of the first online document. In some embodiments, the document archive address may be the archive address of the document storage center. By associating the first online document with the document archive address, the first online document can be stored to the document archive address when certain conditions are met, realizing archive storage of online documents, and facilitating users to organize and summarize online documents. Among them, meeting certain conditions can be after processing service data, or reaching a node, or receiving archive instructions sent by users.

In some embodiments of the present disclosure, further comprising at a predetermined time, the first online stable archive to the associated document archive address, the predetermined time comprising: reaching or completing a predetermined service node of the first application. For example, reaching the archive node, for example, the predetermined archive time after the approval is completed, or completing the service data processing request, for example, to complete the approval request. In some embodiments, by setting the predetermined time, the first online document can be stored only when the service process reaches the predetermined service node, to achieve phased preservation, which can be used as a data preservation process, to facilitate data verification later.

In some embodiments of the present disclosure, associating the first online document with the document archive address comprises: when the first online document is added to the first application, displaying the archive address of the document storage center selection page, or when the predetermined time is reached, displaying the archive address of the document storage center selection page; determining the archive address in response to the operation of the archive address selection page. In some embodiments, the archive address selection page may be displayed, the current user selects the archive address.

In some embodiments of the present disclosure, associating the first online document with the document archive address comprises: determining a first archive address associated with the service data template, determining the document archive address based on the first archive address, wherein the service data is generated based on the service data template, the service data template associated with the first archive address, the first archive address is used to associate with a target online document, the target online document is an online document associated with data established based on the service data template.

In some embodiments, it may be a pre-established service data template, for example, by a backend administrator of the system configuration service data template, the service data template may be configured with a first archive address associated with the service data so that the processing request based on the service data template established, the first online document associated with the first archive address are stored in the specified, so that the specified type of service data, such as a specified type of approval form, can be automatically archived to the first archive address determined document archive address (archive address document may be a first archive address), to avoid errors caused by manual selection by a person associated with the processing node.

In some embodiments of the present disclosure, associating the first online document with a document archive address comprises: in response to an operation of adding a first online document in a display interface of the first application, displaying an archive address selection page, and determining the document archive address based on a selected second archive address. In some embodiments, the document archive address can be the second archive address, and the document archive address is displayed when the first online document is added to the display interface. In other embodiments, the first archive address of the online document can be set in the service data template. The service data is created based on the service data template, and the second archive address is determined based on the first archive address. The second archive address can be a sub-address in the first archive address. For example, the first archive address can be a larger range than the second archive address, and the second archive address is an address selected in the first archive address. This can provide some flexibility to meet actual needs while ensuring archive accuracy.

In some embodiments of the present disclosure, further comprising changing the display position and/or display size of the second display area in response to a third operation. In some embodiments, the display size when the second display area is in the unfolded state can be adjusted. In some embodiments, the service data of the first application can be displayed in the display interface, and the display interface can display the second display area, and the position and size of the second display area can be adjusted as needed to facilitate the user to display as needed. In some embodiments, an object such as a View class can be set in the display interface as a display container, and the display container has an initial height and a maximum height. The internal connection frame (such as an iframe component) is set in the display container, and the internal connection frame is used as the document display area. The position of the second display area can be changed by controlling the display container through the View class object as an operation element. The first event is triggered by clicking on the operation element. At this time, the drag mode is entered and the position of the control mark at this time is recorded. A size adjustment event is triggered by dragging or sliding in the drag mode. The position difference between the obtained position and the position when entering the drag mode (such as the position difference in the height or width of the second display area) is determined. The size of the adjusted display container is obtained based on the position difference and the size of the display container (such as height or width). Safety threshold verification is performed for the adjusted size. If the adjusted size exceeds the maximum threshold or is less than the minimum threshold, the adjusted size is caused to be equal to the maximum or minimum threshold, and then the size of the display container is set to the adjusted size. The size of the display container can be used as the size of the last time the control mark stops control, and the drag mode terminates.

In some embodiments of the present disclosure, in response to the third operation, changing the display position and/or display size of the second display area comprises: if the length of the second display area in the first direction is greater than the first predetermined length, in response to the first predetermined operation, adjusting the length of the second display area in the first direction according to the first predetermined operation. In some embodiments, this embodiment can be used when the second display area is in an unfolded state, the first direction of the second display area can be a height direction (vertical) or a width direction (horizontal). For example, the first side of the second display area can be the head of the second display area, and the second side can be the tail of the second display area. If the distance between the first side and the second side is greater than the predetermined length, it indicates that the area occupied by the second display area is too large. At this time, the first operation can be performed to reduce the display size of the second display area without selecting the second display area. The first predetermined operation can be an operation of scrolling the mouse wheel, such as quickly folding the document display area by scrolling up the mouse wheel. Thus, when the display size of the second display area is too large, the display size of the second display area can be directly reduced by directly performing the first predetermined operation. In some embodiments, after performing the first predetermined operation, it is possible to cease to reduce the length in the first direction when the length of the second display area in the first direction reaches a predetermined ceasing length.

In some embodiments of the present disclosure, adjusting the length of the second display region in the first direction according to the first predetermined operation comprises: if the length of the second display region in the first direction is not greater than the second predetermined length, ceasing to adjust the length of the second display region in the first direction according to the first predetermined operation, wherein the first predetermined length is greater than the second predetermined length. Such embodiment is used when the second display area is in the unfolded state to prevent the problem that the display size of the second display area is too small to cause normal display. A second predetermined length is set for the second display area. When the length of the second display area in the first direction reaches the second predetermined length, the second display area is already small, so the length of the second display area in the first direction is no longer reduced.

In some embodiments of the present disclosure, changing the display position of the second display area and/or display size in response to a third operation comprises: in response to a control identification being located on a first side of the second display area or the second side, changing the style of the control identification; and after the change in the style of the control identification, changing the position of the first side or the second side according to the operation of the control identification to change the size of the second display area. In some embodiments, the first side or the second side may be the top and bottom sides of the second display area, respectively. After the document display area is selected, the style of the control identification can be changed in response to the control identification moving to the first or second side of the document display area. The document display area can be selected by hovering the control identification in the document display area for more than a predetermined time. After the document display area is selected, the display style of the document display area can be changed, such as changing the style of the border of the document display area, and then the control identification can be moved to the first or second side. Moving to the first or second side here can refer to moving to the predetermined range of the first or second side. For example, a hot zone can be set for the first or second side. When the control identification moves to the hot zone of the first or second side, it is determined that the control identification has moved to the first or second side. When the control identification moves to the first or second side, it indicates that the user wants to adjust the first or second side. Therefore, the style of the control identification is controlled to change, and such a change is a kind of feedback so that the user can be aware that he/she now is able to control the first or second side. The position of the first or second side can be changed via the control identification, so that the user can freely adjust the size of the second display area.

In some embodiments of the present disclosure, in response to the control identification being located on the first side or the second side of the second display area, changing the style of the control identification comprises: after the second display area is selected, in response to the control identification is located on the first side or the second side of the second display area, changing the style of the control identification. In some embodiments, the second display area is first selected, and then the style of the control identification is changed, so as to avoid no operation of the second display area.

In some embodiments of the present disclosure, the adjustment frequency of the size or position of the second display area is not greater than a first frequency threshold; or if the adjustment frequency of the size or position of the second display area exceeds a second frequency threshold, the display interface is not refreshed. In some embodiments, the size adjustment frequency may be the number of times the size is adjusted per unit time, the unit time may be, for example, 1 second or other duration, the size adjustment frequency is the number of times the second display area is adjusted, the limited size adjustment frequency is not greater than the first frequency threshold, so as to prevent excessive adjustment times per unit time which would cause lags. When the size adjustment frequency per unit time is higher than the first predetermined frequency, it also means that the adjustment is likely not performed by the user because the speed that can be adjusted by hand will not too fast. Thus, there will be no response to the size adjustment operation that exceeds the first predetermined frequency. In some embodiments, when the size adjustment frequency of the second display area exceeds a second predetermined frequency, the display interface is not refreshed. In this way, by reducing the number of refreshes of the display interface, the consumption of resources is reduced, and when the size adjustment frequency exceeds the frequency threshold, the human eye can hardly change the size. Therefore, the display interface cannot be refreshed.

In some embodiments of the present disclosure, the second display area has a folded state and an unfolded state, and the second display area is switchable between the folded state and the unfolded state. In some embodiments, the folded state can be a state where only the name of the first online document, the classification of the first online document, and the modification date of the first online document are displayed without displaying specific content. At this time, the display size of the second display area can be a predetermined minimum value, and the unfolded state can be a state where more content of the first online document is displayed. In some embodiments, when the second display area is in the unfolded state, the content data carried by the first online document is displayed, for example, it can be a state where at least a portion of the content carried by the first online document is displayed. When the second display area is in the folded state, the content data carried by the first online document is hidden. That is, it is possible that the content data carried by the first online document is not displayed. The size of the second display area in the unfolded state is larger than the size in the folded state. The display size in the unfolded state can be set or a default value. By setting the folded and unfolded states, the users are allowed to reduce the display area occupied by the first online document when they make no reference to the first online document.

In some embodiments of the present disclosure, when the document display area is in an unfolded state, the content carried by the first online document is displayed; or when the document display area is in a folded state, the content carried by the first online document is hidden and the abbreviated information of the first online document is displayed. In some embodiments, the content carried by the first online document may include specific content in the first online document, and the specific content of the first online document can be viewed in the unfolded state, while in the folded state, the content carried by the first online document is not displayed, and only summary information such as document name, document modification time, and document author is displayed.

In some embodiments of the present disclosure, the second display area having an associated control; if the second display area is in the folded state, the control is used to unfold the second display area after being triggered; or if the second display area is in the unfolded state, the control is used to fold the second display area after being triggered.

In some embodiments, the second display area has an associated control, the control may be displayed in the second display area. The control may be displayed in the second display area or at a fixed position of the display interface of the first application, for example, always fixed at the top or bottom of the screen, without changing as the content of the display interface changes. When displayed in a fixed position of the display interface, it will not change with those operations that will change the content of the display interface such as scrolling of the mouse. The control can always be fixed predetermined position of the display interface. The display interface can automatically be located to the second display area after the control is triggered, so that the user can quickly locate to the second display area no matter where he/she is in the user interface. While the second display area is in the unfolded state, the second display area is folded by triggering the control. While the second display area is in the folded state, the second display area is unfolded by triggering the control. In some embodiments, the unfolded state may display the content of the first online document and possibly also display the title, author and other associated information. In the folded state, the content of the first online document can be hidden, and the abbreviation information of the first online document can be displayed. The abbreviation information may include title, author, etc.

In some embodiments of the present disclosure, the second display area has a predetermined size range. Changing the display size of the second display area in response to a third operation comprises: determining a target display size of the second display area according to the third operation; if the target display size is greater than the maximum value of the size range, setting the display size of the second display area to the maximum value of the size range; or if the target display size is less than the minimum value of the predetermined size range, setting the display size of the second display area to the minimum value of the size range. In some embodiments, after the user performs an adjustment operation on the target display area, the target display size is determined according to the adjustment operation. If the target display size is in the size range, the display size of the document display area can be directly adjusted to the target display size. If the target display size is outside the size range, the display size of the document display area is set to the maximum or minimum value of the size range. By setting the size range, the problem of poor User Experience caused by adjusting the document display area to be too large or too small can be prevented.

In some embodiments of the present disclosure, the content carried by the first online document is updated as the service data evolves. In some embodiments, the content carried by the first online document may include processing summary information of the service data, and the processing summary information is updated as the flow of the service data progresses, so that the content carried by the first online document can reflect the processing progress of the service data.

In some embodiments of the present disclosure, the content carried by the first online document includes: service flow information of the service data and/or content information of the service data. In some embodiments, the first application has service flow information, which can be, for example, a processing flow of service data, and the content information of the service data can be, for example, a specific content represented by the service data. The content information of the service flow information and the service data carried by the first online document improves the degree of aggregation of information and facilitates handlers to process service data.

In some embodiments of the present disclosure, the content carried by the first online document includes data to be referred to by the service flow of the service data. In some embodiments, the service flow of the service data needs to refer to data during the promotion process, such as the processing opinions of the handlers of the previous node need to be referred to during the promotion of the service process. These data that need to be referred to can be carried in the first online document, so that the service flow does not need to rely on external data for promotion.

In some embodiments of the present disclosure, the content carried by the first online document includes link information, and the link information displays a predetermined interface of the first application after being triggered. In some embodiments, the predetermined interface of the first application can be a processing interface of the first application's service data, or a display interface of the processing information of the first application's service data, so that during viewing the first online document, the predetermined interface can be opened directly by triggering the link without exiting the first online document.

In some embodiments, an apparatus for data processing for an application is proposed, comprising: a display unit configured to display service data in a first display area of a first application display interface, and to display first online document information in a second display area of the first application display interface, the first online document being used to carry content required for processing the service data; and a processing unit for processing the service data in response to a first operation initiated based on the content carried by the first online document.

In this disclosure, the apparatus is provided components for implementing the method. The description of the method also applies to the device and is not repeated here.

The present disclosure provides a method of information processing, comprising: determining a first application, the first application is associated with the first service logic, and the first application processes the service data of the first application according to the first service logic; establishing an association between the first application and the first online document; performing first processing on service data of the first online document based on information related to the service processing node of the first application.

By processing the data of the first online document according to the information related to the service processing node of the first application, the data processing of the first online document can adapt to the service logic of the first application itself, so that the data carried by the online document can reflect or adapt to the service logic. On the one hand, when using the first application for service processing, the convenience of online collaboration and the like of online documents can be utilized, and on the other hand, it can prevent the service logic from being destroyed, e.g., due to the collaboration openness of online documents and the like, thereby improving the reliability of services.

In some embodiments, the first application may have a variety of presentation forms, such as standalone applications, or embedded or based on subroutines in other programs, applet and the like.

Establishing an association with the first online document in the first application may include linking or displaying the first online document in a processing interface of the first application.

In some embodiments, the information related to the service processing node includes at least one of the following: the service node, personal information associated with the service node, and service data associated with the service node.

Performing first processing on the data of the first online document according to information related to the service processing node of the first application comprises one or more of the following: according to the current service processing node, processing the display information, permission information, and content data carried internally of the first online document; according to the personal information associated with the service node, processing the displayable content, display format, and permission information of the first online document for the person; generating the first online document or processing the content data carried in the first online document according to the service data associated with the service node.

In some embodiments, the first application may be an approval application, the information related to the service processing node includes more than one approval node, the person associated with the approval node, such as the approver, person to be copied, bill of lading person (request approval person) and so on.

In some embodiments of the present disclosure, the first application may be a reporting program, and the related information of the service node includes more than one reporting node and the reporting node associated person such as persons who are reported to, the persons who are copied, and the like.

Within the enterprise, sometimes it is necessary to approve project content, work content, product qualifications, and rules and regulations. Usually, the processing process is triggered first, and then approval tasks are created. Approval tasks usually need to be approved by multiple responsible persons.

Taking the approval process as an example, this public plan is introduced as an example: sometimes within the enterprise, it is necessary to approve some matters, such as approving documents, systems, qualifications, contracts, etc. During the approval process, it is sometimes necessary to consult relevant documents as a reference.

In some embodiments, the information processing method comprises:

S11: create a first processing item having a first online document in response to a first operation event.

In some embodiments, the information processing method can be used for a first application such as an approval program and can create a first processing item (the first processing item can be service data) in the first application. The first operation event, for example, can include one or more operations, such as creating a processing item, which can be a first operation event executed by the creator of the first processing item. The first processing item can be an official document approval, leave approval, system approval, decision approval, etc. The first processing item has a first online document (also called a cloud document). The first online document can be stored in a cloud space, for example, it can be stored in a server. The first processing item can be displayed in the form of a task item, in which a document display area can be inserted and displayed in the document display area.

S12: In response to the second operation event, trigger the processing flow of the first processing item.

In some embodiments, the second operational event may include one or more operational steps, the second operational event may be, for example, an event to submit processing items, after triggering the second operational event, the first processing flow starts processing items (service processing flow), may be executed according to the first service logic starts service processing logic.

In some embodiments of the present disclosure, it is possible to create a first processing item having a first online document, so that the person for review can view the first online document in the processing item, the first online document, for example, may be a first processing item documents associated information, so as to facilitate handlers to review the associated information when approving.

In some embodiments of the present disclosure, before creating the first processing item in response to the first operation event, further comprising: in response to the process creation operation, setting document permissions of the processing node of the processing item and the handler of the processing item. In some embodiments, the processing flow of the processing item may include one or more service processing nodes, and the service processing node may have a corresponding handler, and document permissions can be set for the service processing node of the first processing item. The document permissions of the handler can be, for example, permission to view and permission to edit, and the handler's permissions for online documents in the processing item are determined based on the document permissions to achieve permission management. In some embodiments, the online document permission to view and permission to edit can be set for the service processing node, and which nodes can read or edit online documents can be set.

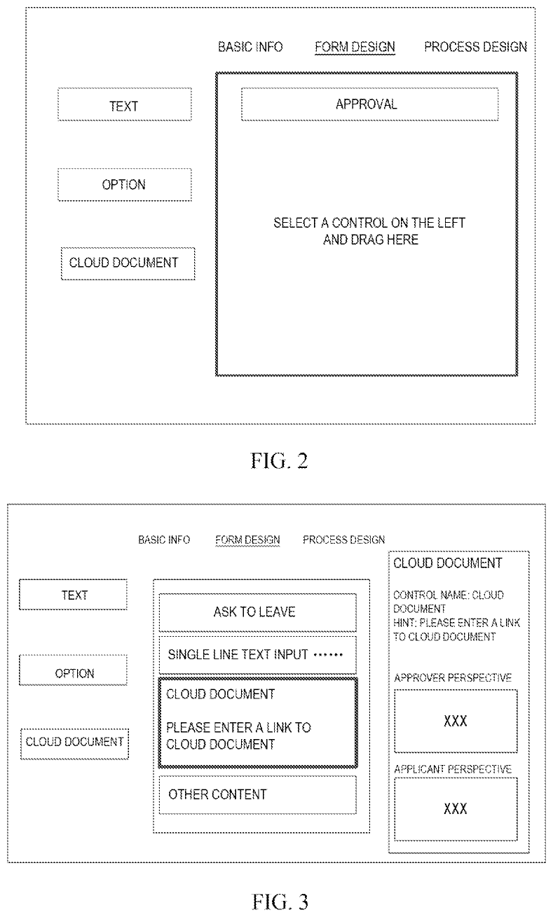

In some embodiments of the present disclosure, before creating the first processing item in response to the first operation event, it further comprises: creating a processing item template with controls for adding online documents in the processing item template; the first processing item is established based on the processing item template. In some embodiments, the processing item template can be a form module, and the processing item template can be pre-designed for creating processing items. Please refer to FIG. 2, which schematically shows the processing item template. The processing item template can have controls for adding online documents (cloud documents), for example, multiple controls can be provided for selection. Please refer to FIG. 3, where text controls and cloud document controls are added, which can be processing item templates created by the administrator of the approval program. After the processing item template is created, the creator (applicant) of the first processing item initiates an application and creates the first processing item based on the processing item template and joins the first online document through controls for adding online documents. Of course, other controls can also be added to the processing item template by triggering the Add Control option, and a widget name can be entered after adding other controls. For the control for adding an online document, it has a text box, which is used to display the online document. The text box has a default prompt text (such as “Please enter the cloud document link” in FIG. 3), and the prompt text can be edited. Different languages can be supported for the prompt text. In some embodiments, the first processing item can be output, for example, it can be printed or stored as a specific file. After the first approval document is output, the output content can display the control included in the first processing item and the content in the control, that is, the name of the control for displaying the online document and the document name of the first online document are output. For example, the name of the control for adding the online document is “cloud document”, and the document name of the first online document will be output after the first approval document is output. In some embodiments, after creating the processing item template, a preview of the item template can be displayed, for example, a preview from different user perspectives (such as the approver's perspective and the applicant's perspective shown in FIG. 3) can be displayed to view the implementation effect.

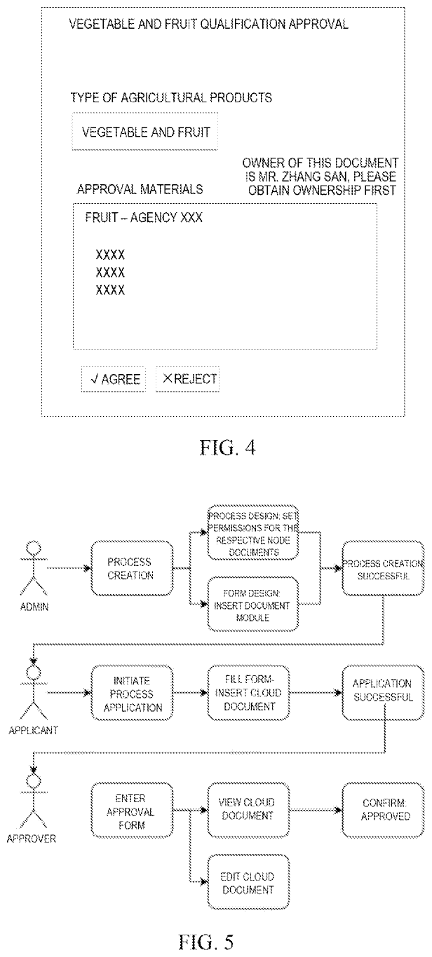

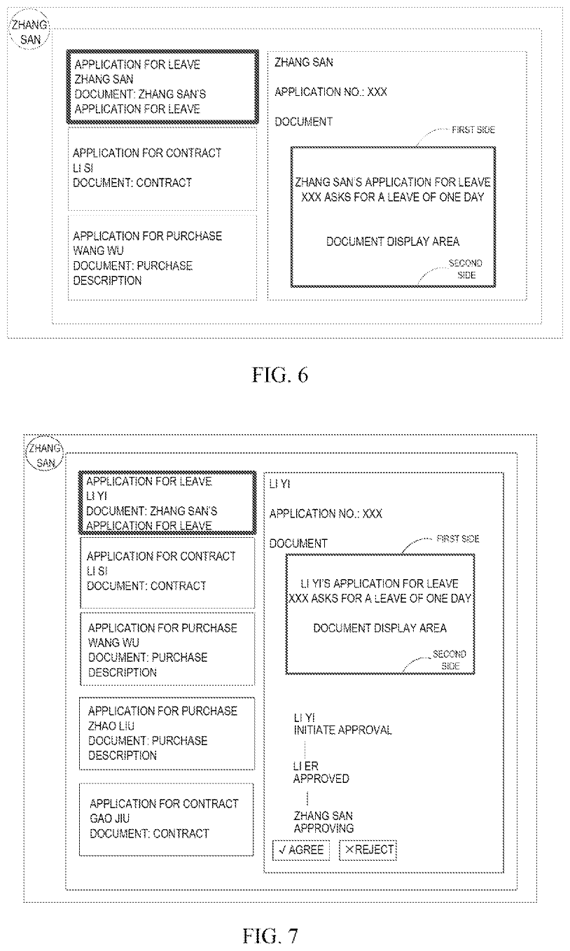

In some embodiments of the present disclosure, in response to a first operation event, creating a first processing item, comprises: in response to a trigger operation of the processing item creation control, displaying an item creation interface (the item creation interface may be an item creation template), displaying a control for adding an online document in the item creation interface, in response to a trigger operation of the control for adding an online document, displaying a document addition interface. In some embodiments, the document addition interface may display a recommended online document, and a search box may be displayed in the document addition interface. Information such as document title or document address can be entered in the search box to search for online documents. When searching for online documents, the current user's permissions for the online document can be displayed in the association area of the searched online document, and the searched online document can be selected and added. The first online document can be added to the document addition page, and the first online document can be displayed in the document display area of the event creation interface. The associated information of the first operation item can be input in the event creation interface, and the creation of the first operation item can be completed in response to the trigger operation of the determination control of the document creation interface. In some embodiments, only the owner of the first online document can add the first online document to the first operation item, as shown in FIG. 4. If the creator of the first operation item is not the owner of the first online document, a prompt message can be issued when adding the first online document in the first operation item. The prompt message can display the owner of the first online document, such as displaying the communication method or service card of the owner of the first online document, or a control for contacting the owner of the first online document after being triggered can be displayed in the prompt message, which is convenient to apply for permission from the owner of the first online document.

Information of the first online document is displayed in a second display area of the first application display interface, the first online document information carrying files required for processing the service data. In response to an online document addition control being triggered, an existing first online document can be added, or a first online document can be created.

In some embodiments, as shown in FIG. 5, the process is created by the administrator of the first application, and then the process design is performed to set the document permissions of each node, and the form design is performed to insert the document module (used to add controls for online documents). After the processing flow is successfully created, the applicant initiates the process application, fills in and adds online documents on the basis of the item template, and approves the application by a person associated with the service processing node (such as a handler). When approving, it is possible to view and edit cloud documents. After confirming that there are no errors, the approval is passed, and the service processing node flows to the next node.

In some embodiments of the present disclosure, further comprising: when creating an item template, determining a save address of an online document in the item template, saving an online document in a processing item created based on the item template to the save address. Alternatively, when creating a first processing item, determining a save address of a first online document, saving the first online document to the save address. In some embodiments, a save control may be provided to control whether to save the online document by the save control. In response to determining that the online document is to be saved, an interface for determining the address to save the online document is provided, and the address selected or entered is used as the address to save the online document. In some embodiments, the save address of the online document, such as the save address of the first online document, may be a node of a document storage center, with the selected cloud document storage center (referred to as wiki) node as the save address, and an option is provided to select whether to give the owner of the online document (such as the first document) to the wiki owner.

Associating the first online document with a document archive address comprises: determining a first archive address associated with a service data template, determining the document archive address based on the first archive address, wherein the service data is generated based on the service data template, the service data template being associated with the first archive address, and the first archive address being associated with a target online document, the target online document being an online document associated with data established based on the service data template.

In some embodiments of the present disclosure, further comprising: in response to the trigger operation of the handler of the current service processing node of the processing flow on the first operation item, viewing the first operation item, and in response to the handler's processing operation on the first operation item, the corresponding processing item is executed according to the processing operation. The handler of the current service processing node can view the first operation item, and when it has the permissoin to read or edit the first online document, it can read or edit the first online document. The handler can process the operation item, such as agreeing that the first operation item makes the processing flow to the next service processing node, or opposing the first processing item, thereby ending the processing flow.

In some embodiments of the present disclosure, a first processing item is created in a control (e.g., applet) of the target communication software. In some embodiments, the first application is associated with the target communication software, and the account in the first application and the target communication software are associated with each other. The method in the present disclosure embodiment can be executed through the control of the target communication software, such as creating a first processing item and triggering a processing flow of the first processing item.

In some embodiments of the present disclosure, further comprising: displaying the first processing item in the control target communication software handler node of the processing flow. In some embodiments, the executor of the method may be a first application such as an approval program, the first application may communicate with each other associated with the target communication software, the target communication software may be, for example, even if the communication software, the user account of the first application and the target communication software are associated with each other, matching communication through the account, thereby achieving integration between the two software systems, the communication between the first application and the target software is achieved through the account as a match, the handler of the nodes in the target communication software can process and access the first processing item and the first online document through the target communication software, comment on the first online document with comment permission, read the first online document with permission to view, edit the first online document with permission to edit, and the operations performed by the handler on the first processing item and the first online document on the target communication software will be synchronized to the first application, so that the user can conveniently process the first processing item without opening the access permission of the first application for the user. Through the target communication software, external users of the first application can use the permission diffusion capabilities such as comments and editing of the first document Complete the processing or material submission work of the first processing time limit. For example, the control for displaying the first processing item can be embedded in the applet of the target communication program, such as the approval component, reporting component, task and key node component or other components of the target communication software. The first processing item and the first online document can be viewed and processed through the component. This technical solution can be used for any service scenario that needs to use documents for information bearing. FIG. 5 schematically shows the display interface of the first application, which displays the processing item list, and the processing items selected in the processing item list will be displayed in detail.

In some embodiments of the present disclosure, the entry identifier of the first processing item (item in the processing item list) is displayed in the target communication software of the associated person (creator, handler, etc.) of the first operation item. After the entry identifier is triggered, the content of the first processing item is displayed, and the name of the first online document in the first processing item can be displayed in the entrance identifier. As shown in FIG. 7, relevant information of the service processing node of the service processing flow can also be displayed, such as the associated person of the service processing node and the processing status of the first processing item.

In some embodiments of the present disclosure, the display interface of the first processing item has a document display area for displaying the first online document, the document display area, the size and/or position of the document display area can be adjusted. In some embodiments of the present disclosure, the internal connection frame can be used as the document area to display the first online document by setting an internal connection frame in the control displaying the first processing item. The internal connection frame can be an iframe frame, for example, when displaying the first processing item in the applet of the target communication software, the internal connection frame can be loaded in the applet to display the first online document in the inline frame. The size of the document display area displaying the first online document can be conditioned, the length and width of the document display area can be adjusted, and the display position of the document display area can be moved freely, thereby improving the user's user experience.

In response to the third operation, the display position and/or display size of the second display area are changed.

In some embodiments, the adjustment of the length dimension of the document display area can be realized in the following way. Herein the length dimension can be the display length of the document display area, and the display length can refer to the size in the longitudinal direction of the display interface. In the control for displaying service data, a display container is set, the display container can be a view object, and the display container can have an initial length and a maximum length. The internal connection frame is set in the display container, and the length dimension of the document display area can be changed by dragging the edge of the display container. The display container is used as an operation object for dragging, and the display container can be set in the display area of the first operation item, and the height of the screen z-axis direction (z-axis direction perpendicular to the screen, facing the outside of the screen) in the display area of the first operation item is higher than that of other elements in the display area of the first operation item, so as to prevent the display container from being blocked by other elements, and the length dimension of the display container is not less than the minimum predetermined value,

In some embodiments of the present disclosure, the document display area has an associated operation element, the operation element can be, for example, a display container as described above, which enters a first mode by triggering the operation element. After entering the first mode, the size of the document display area can be adjusted by dragging or in a predetermined way. In some embodiments, after the operation element is triggered, a current first height position (such as the position of a mouse or finger) is recorded. The current first height position can refer to a position in the direction of the length of the document display area. In the first mode, a predetermined operation such as dragging or sliding can be used to obtain a second height position (such as a height position in the direction of the length of the document display area) at the end of the predetermined operation. A height difference value is determined based on the first height position and the second height position. According to the height difference value and the size of the document display area before the predetermined operation is performed, the size of the document display area is adjusted to obtain and display the adjusted document display area. In some embodiments, the size range of the document display area is set in advance, and if the size of the adjusted document display area is greater than the maximum value of the size range, the size of the document display area is set to the maximum value of the size range. If the size of the adjusted document display area is smaller than the minimum value of the size range, the size of the document display area is set to the minimum value of the size range. A specific embodiment is as below: triggering the start event by clicking on the operation element, entering the drag mode at this time and recording the height position (mouse or finger) in the longitudinal direction of the document display area, holding down the mouse or holding the screen (touch screen) in the drag mode, dragging or sliding triggers the movement adjustment event, performing a difference calculation (negative value exists) of computed height position and the height position recorded when entering the drag mode, and then adding the difference value to the size of the existing document display area to obtain a new size. A threshold verification is made for the obtained new size. If it exceeds the threshold value, stop it at the threshold edge (i.e., maximum or minimum value), then set the size of the document display area, and finally release the mouse (or finger), record the size set last time in this drag mode, adjust the size of the document display area according to the size set last time, and then close the drag mode.

The size range of the second display area is predetermined; changing the display size of the second display area in response to the third operation comprises: determining the target display size of the second display area according to the third operation; if the target display size is greater than the maximum value of the size range, setting the display size of the second display area to the maximum value of the size range; or if the target display size is less than the minimum value of the predetermined size range, setting the display size of the second display area to the minimum value of the size range.

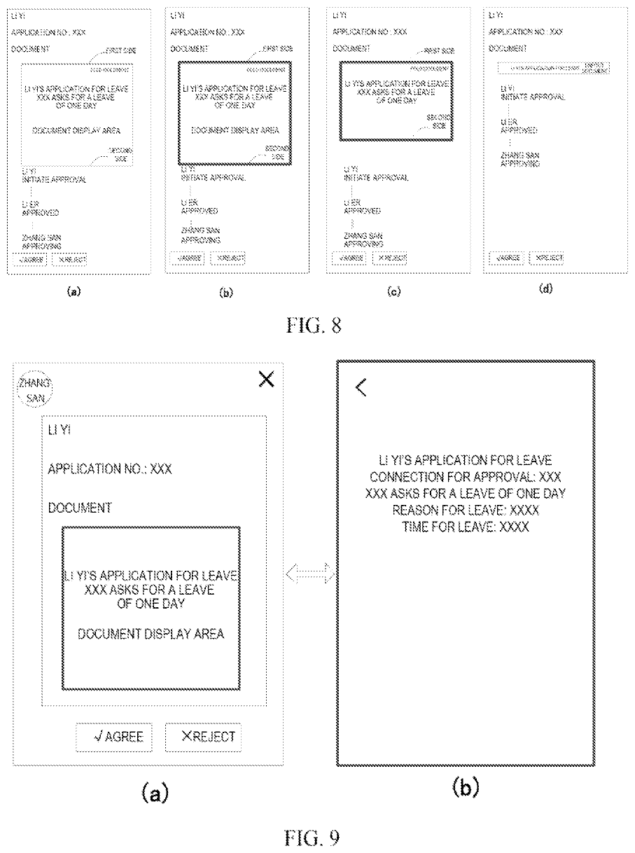

In some embodiments of the present disclosure, please refer to FIG. 8(a), the document display area has a first side and a second side, which can be the document display area in the longitudinal direction of the display interface displaying service data edge. In response to the selection operation of the document display area, which can be a control identification such as a mouse hovering in the document display area, the display style of the document display area can be changed after selecting the document display area, as shown in FIG. 8(b). In response to the first predetermined operation performed after the document display area is selected, the first side of the document display area is fixed in the display interface position, and the position of the second side in the display interface is changed. For example, the first predetermined operation may be an upward scrolling operation of the mouse, the first side may be the upper edge of the document display area in the longitudinal direction of the display interface, and the second side is the lower edge of the document display area in the longitudinal direction of the display interface. After selecting the document display area, by rotating the mouse shaft, the upper edge can be fixed while the position of the lower edge can be changed, thereby changing the size of the document display, as shown in FIG. 8(c). For example, the document display area can be quickly folded by rotating the mouse shaft in a first direction and can be quickly folded by rotating the mouse shaft in a second direction.

In some embodiments of the present disclosure, when the distance between the first side and the second side of the document display area is greater than the predetermined distance, if the second predetermined operation is performed, the first side is fixed at the position of the display interface, and the distance between the second side and the first side is reduced. For example, the first side is the upper edge of the document display area, and the second side is the lower edge of the document display area. When the distance between the first side and the second side is large, the user's view of the first operation item will be hindered, so the second predetermined operation can be performed (such as scrolling up the mouse shaft), the first side is fixed differently, the position of the second side is changed to reduce the distance between the first side and the second side, and the technical effect of quickly folding the first online document is achieved. Solve the problem that the user's view of other information is hindered due to the long document display area, that is, when the document display area is greater than or equal to the default height, the head (first side) of the document display area can be fixed when scrolling up. In some embodiments, The size of the region in the vertical direction.

When the length of the second display area in the first direction is greater than the first predetermined length, in response to the first predetermined operation, the length of the second display area in the first direction is adjusted according to the first predetermined operation.

In some embodiments, as shown in FIG. 8(c), the document display area displays a folding control. After the folding control is triggered, the document display area is folded, for example, the document display area is hidden. At this time, only the identification of the first online document can be displayed. After the folded document display area, as shown in FIG. 8(d), the expansion identification can be displayed. After the expansion identification is triggered, the document display area is displayed.

The second display area has a folded state and an unfolded state, and the second display area can switch between the folded state and the unfolded state. The second display area has associated controls.

In some embodiments of the present disclosure, after the document display area is selected, when the control mark (e.g., a mouse) moves to the edge of the first side or the second side of the document display area may change the style of the control mark, the control mark after changing the style, the control mark can be used to change the position of the first side or the second side, thereby changing the size of the document display area.

In response to the control identification being located on the first or second side of the second display area, the style of the control identification is changed, and after the style of the control identification is changed, the position of the first or second side is changed according to the operation of the control identification to change the size of the second display area.

In some embodiments of the present disclosure, in the display interface of the first processing item, the default size of the document display area of the first online document depends on the content amount of the first online document. When the content amount of the first online document is greater than the content amount threshold, the first default size can be used, and when the content amount of the first online document is not greater than the content amount threshold, the second default size can be used, and the first default size is greater than the second default size. The document display area can be located in an area below the title of the first processing item in the display interface of the first processing item. In some embodiments, the reference size is determined based on the data amount of the content data carried by the first online document. If the reference size is within a pre-set size range, the display size of the document display area is set according to the reference size. If the reference size is greater than the maximum value of the size range, the display size of the document display area is set according to the maximum value of the size range, so that the display area size can be automatically adapted according to the document content amount. At the same time, it is possible to avoid impacting the display of other service information if the document display area is too large, thereby improving the space utilization.

In some embodiments of the present disclosure, in order to ensure the smoothness of control and meet performance requirements, the size adjustment frequency of the document display area can be limited, and the size adjustment frequency of the document display area per unit time is not greater than the predetermined frequency, for example, the frequency threshold for controlling the frequency of resetting the size per second, and whether to refresh the display interface when the frequency exceeds the frequency threshold, for example, when the size adjustment frequency of the document display area exceeds the frequency threshold, the display interface is not refreshed to reduce performance requirements, so that when adjusting the size of the document display area multiple times, the display interface can be refreshed only when the time after adjusting the document display area reaches the predetermined time length and the size adjustment operation of the document display area is no longer detected, thereby saving computing power.

The adjustment frequency of the size or position of the second display area is not greater than the first frequency threshold; or if the adjustment frequency of the size or position of the second display area exceeds the second frequency threshold, the display interface is not refreshed.

In some embodiments of the present disclosure, as shown in FIG. 9(a), when displaying the first processing item, after the area where the first online document in the first processing item is triggered, as shown in FIG. 9(b), the first online document can be displayed in full screen. This can meet the browsing needs of mobile devices. When the first online document is displayed in full screen, the first online document can be displayed in full screen, and the first processing item will continue to be displayed after exiting.

In some embodiments, the creator of the service data is the owner of the first online document, and the creator needs to give the first online document open permission, so that other users can have reading, editing and other permission to solve the processing problems of different users. In some embodiments, the handler of the node of the processing flow can be added as a collaborator of the first online document, and the node can be given the required or predetermined document permission. In other embodiments, the link sharing function of the first online document can be turned on, and the user who obtains the sharing link of the first online document can be set with predetermined permission (such as permission to view or permission to edit), and a password can be set for the sharing link. In this way, by adding the sharing link of the first online document in the service data, other users can obtain predetermined permission when opening the link of the first online document in the service data.

In some embodiments of the present disclosure, the creator of the first processing item is the owner of the first online document. After triggering the processing flow of the first processing item, the ownership of the first online document is transferred from the creator of the first processing item to the first application, and the creator can retain the permission to view of the first online document but does not retain the permission to edit for the first online document. When triggering the processing flow of first processing item, the processing permission of the non-current service node of the processing flow can be read but cannot be edited. Only the current service node may have permission to edit (whether it has permission to edit depends on whether the permission to edit are opened for the handler of the node in advance); after the processing flow of the first processing item is completed, the ownership of the first online document is returned to the creator of the first processing item.

In some embodiments, after the first processing item is initiated, if the creator of the first processing item is not the owner of the first online document (i.e., the one with ownership), the first online document may not be added to the first processing item, and the first online document can only be added to the first processing item when the owner of the first online document is the creator. After the processing flow is triggered to start, the ownership of the first online document is transferred to the first application, so that the first application can assign the permission of the first online document to the handlers of other nodes. After the processing flow of the first processing item is completed, the ownership is returned to the creator.

In some embodiments, during the execution of the processing flow of the first processing item, according to the predetermined setting, the permissions (permission to view or permission to edit, where the permission to edit includes the permission to view) for the handlers of the service node has are opened, and the permission to view and permission to edit can be opened by default to the handlers, or the permission to edit can only be opened to the scheduled handler. In addition, if the permission to view is not opened for the handler of the current node, the handler of the current node cannot read the first online document.

In some embodiments, after the processing flow of the first processing item is completed, the node handler will withdraw the permission to edit for the first online document, and the node handler can set the permission of the first online document to permission to view.

In some embodiments of the present disclosure, during the execution of the processing flow, the first online document permission to edit is only opened to the handler(s) of the current service processing node of the processing flow who has the permission to edit; after the processing flow after ends, the document permission assigned to the handler of the service processing node is withdrawn.

In some embodiments, if the creator revokes the processing flow of the first processing item, ownership of the first online document can be returned from the first application to the creator of the first processing item, and all service processing nodes are recovered. Permissions (permission to view and permission to edit) for the first online document, that is, if the handler of the service processing node restores the permissions of the first online document to the state before creating the first processing item.

In some embodiments of the present disclosure, after the handler of the current service processing node rejects the first processing item, the handler of the current service processing node recovers the permission of the first online document and returns the ownership of the document to the creator of the first processing item.

In some embodiments of the present disclosure, when the handler of the current service processing node transfers the processing task of the first processing item to a further handler, the permission of the first online document of the handler of the current service processing node is applied to the further handler, for example, if the handler of the current service processing node has permission to view, the further handler will also be assigned the permission to view, and the handler of the current service processing node retains the permission of the first online document.

In some embodiments of the present disclosure, after the handler of the current service processing node adds a service processing node, the handler of the current service processing node applies the permission of the first online document to the handler of the added service processing node, and retain the permission for the first online document of the handler of the current service processing node. If the handler of the current service processing node has permission to view to the first online document, the handler of the added service processing node will also have permission to view.

In some embodiments of the present disclosure, after the service processing node in the processing flow is removed, the handler of the removed node will recover the permission of the first online document, and the handler of the removed service processing node can restore the permission of the first online document to the state before the creation of the first processing item.

In some embodiments of the present disclosure, when the handler of the current service processing node returns the processing flow to the previous node, the handler of the current service processing node applies the permission of the first online document to the handler of the previous node. For example, the handler of the current service processing node has permission to view, and the handler of the previous node will also have permission to view. In some embodiments, if the service processing node is returned to the creator of the first processing item, it is necessary to open the permission to edit of the first online document to the creator.

In some embodiments, after the first processing item is copied or share, the copied and shared user of the first online document in the first processing item only has viewing permission, does not have permission to edit.

In some embodiments of the present disclosure, during the execution of the processing flow of the first processing item, the first handler is a handler of at least two service processing nodes. After the first handler processes the first processing item at a service processing node for which he is responsible, and there are still unprocessed service processing nodes for which the first handler is responsible, if the content of the first online document changes, the first handler processes the first processing item again at the unprocessed service processing node. For example, there are three service processing nodes, and handler A is responsible for the first and third nodes. The current processing flow proceeds to the second service processing node. At this time, if the content of the first online document changes, handler A is still required to process the first processing item at the third service processing node, and handler A will not stop processing the first processing item because handler A has already processed the first processing item.

In some embodiments of the present disclosure, the first processing item is combined with the first online document to improve communication efficiency and support height adjustment of the document display area of the first online document and free drag and drop, and can display the first online document in full screen and hide the full screen display.

For the approval scenarios of enterprises for complex decision-making information, such as document approval such as official documents and systems, as well as attachment approval such as supplier/product qualifications and contracts, some solutions disclosed herein, by deeply integrating approval with cloud documents, open up the account, permission, information notification and other fields of approval and cloud documents at the bottom, embed cloud document components through iframes and other methods at the front end, and support approvers to freely drag the displayed window size, ultimately achieving the best experience of approval combined with cloud documents.

Regarding the accounts, permissions, information notifications, and other fields of low-level applications such as approval and cloud documents, the permissions and information notifications of cloud documents (also known as online documents or collaborative documents) can be processed according to the service processing logic of the application. For example, predetermined cloud document permissions can be opened for predetermined service node handlers or personal roles, or when the content of cloud documents changes, such as when the comment content changes, notification messages can be sent to relevant handlers of predetermined nodes of the application, so that relevant person can timely or change the content of cloud documents. Since the notification is related to handlers at the service nodes of the application, the integration of these two can be strengthened to ensure that the message can reach the service handlers of the service program in a timely manner.

In some embodiments of the present disclosure, the cloud document component can be added to the approval flow (also referred to as the approval program): through approval admin, the cloud document component can be added, and the name, display conditions, printing status, archive location, etc. of the cloud document can be set.

In some embodiments, the integration of applet and cloud documents can be achieved: by solving the account, permission, and message communication problems between applet and web applications (such as cloud documents), the integration and interoperability of the two can be achieved.

In some embodiments, regarding the display of cloud documents, the cloud document can be embedded in the approval page by iframe, supporting the approver to freely drag the document window size, and supporting one-click hide, one-click full screen and other operations.

In some embodiments, the current tenant approval and other applications can be achieved in collaboration with an external tenant, wherein the tenant can be understood as a group identifier or an organization identifier, generally different enterprises can be understood as different tenants. By opening external permission to edit through the cloud document, it is possible to solve the problem of cross-tenant content approval.

In some embodiments, regarding the operation permissions of approvers on cloud documents, approval admin can be used to support setting the permissions of each approver or approval role on cloud documents, such as permission to edit, readable permissions, sharing permissions, etc.

In some embodiments, regarding the transfer of cloud document owners, the application is associated with the cloud document, and after the application proceeds to a predetermined service processing node or reaches a predetermined service processing state, the owner of the cloud document can be changed to the application or a service handler related to the cloud document in the application, thereby facilitating subsequent permission changes. For example, in the approval scenario, after submitting approval, the document owner is transferred from initiator to the application by calling up the document owner transfer interface, which facilitates subsequent application to change document permissions.

In some embodiments, regarding the cloud document permission processing, in the approval scenario, along with the approval processing such as approving/rejecting, forwarding, adding/removing signatures, returning, copying, sharing, etc., the document “update collaborator permission” interface is retrieved to change the cloud document permission.

In some embodiments, based on the change of document content, the handler that appear repeatedly in the application can be deduplicated to avoid the same person from doing duplicate processing of the same document content. For example, in the approval scenario, when the same approver appears repeatedly in the approval process, if the document content changes, it needs to be re-approved; otherwise, it is automatically skipped, that is, if the document content has not changed, the approver of the current approval node can automatically skip if the document content has been approved before in the approval process.

In some embodiments, regarding the writing of document content, the service data or a processing node link related to the service data can be embedded in the document through the association between the service data of the application and the document, or a new document can be generated based on the above service data or processing node link. For example, in the approval scenario, the approval link can be written into the document through the association between the approval documentation and the document, and the approval can be returned to the document with one click to view the approval details.

In some embodiments, the approval admin can add a new category “cloud work”, add a “cloud document” control, it is possible to set the widget name, prompt text, permission settings entry.

In some embodiments, automatic archiving can be supported, and whether to archive cloud documents after approval can be selected. If archived, open the wiki and select the specific wiki node to be archived; it is possible to also choose whether to transfer the owner of cloud documents to the wiki owner.

By matching the account of the application associated with the cloud document (for example, the approval program and the cloud document share the same ID, or the IDs of the two are related) as the ID, communication is carried out, and the ability of permissions such as comment notification, document reading and editing is opened up, and the integration of the two applications is realized. The original submitter does not have permission to access the other party's approval program and cannot submit materials. With the permission diffusion ability of the document, external users can complete the work of material submission.

Application scenarios: cloud document components can be embedded in any applet, including applet approval, reporting, OKR, and any applet.

This technical solution can be used for any service scenario that requires information bearing with documents.

Web cloud documents and applet approval applications can be integrated and displayed through iframes.

The best browsing and approval experience can be achieved by highly adapting the front-end to the cloud document component and supporting free dragging of the document window.

Implementation of freely dragging the height of the document window:

Layout: In the applet, View is used as a container with an initial height and a maximum height. The iframe component of the document is placed inside the View container, and a View is added as a drag-and-drop operation element. The operation element is located at the bottom of the container element, with a higher level than any other element in the container and a slight height guarantee that it can be clicked.

Interaction: Trigger the touchstart event by clicking on the operation element, enter drag mode at this time and record the height position (mouse or finger) at this time, drag or slide while holding the mouse or screen (touch screen) in drag mode to trigger the touchmove event, calculate the difference between the obtained position height and the recorded height when entering drag mode based on the mouse (or finger) position obtained in each touchmove event (there is a negative value), then add the calculated height difference value to the new height value based on the existing container height, check the safety threshold for the obtained new height, if it exceeds the threshold, stop it at the threshold edge (i.e. maximum or minimum value), then set the new height of the container, and finally release the mouse (or finger) to set the last height in this drag mode in the touchend event and close the drag mode after recording the container height.

Cut-off: In order to freely control the balance between fluency and performance, the cut-off control can be performed on the height setting frequency. Reset the height frequency every second and whether to refresh the interface when exceeding the threshold. The actual implementation frequency can achieve stepless control between the touchmove event trigger frequency and 0 times/second, but the actual product will be limited to a fixed value. The specific value should be considered comprehensively according to the actual product requirements, fluency experience, and software performance.

It supports mobile adaptation. Click on the cloud document component to browse in full screen.

Regarding the processing of cloud document permissions, in some embodiments, in the approval scenario, external permission to edit can be opened for cloud documents by approving initiators (such as document owners), so that external tenant content supply persons have document permission to edit to solve cross-tenant content approval scenarios.

Method 1: Add external collaborators as document collaborators and grant permission to edit.

Method 2: Enable link sharing, set it to “editable by people who get links on the Internet”, and add a password.

In the approval process, each approver can be granted permission to view and edit documents.

An example explanation of changes to document permissions is as follows:

About permission withdrawal: After the initiator submits the approval, the document owner is transferred to the approval application. The approval application revokes the permission to edit of the document collaborator does not revoke the readable permission, and others can only read it.

About permission release: Return to the initiator the document owner is still the approver, but the permission to edit is released to the original editor or owner between submission for approval.

About permission granting: During the approval process, according to the background settings, the reading and permission to edit of the corresponding approval process approver are enabled (the background sets the reading/permission to edit of specific approvers), and the “readable” and “edit” are enabled by default. The permission to edit is only granted to the approver.

If the “Read” permission is not enabled, the current node person is not visible to the “cloud document control”.

About permission withdrawal: After the approval is completed, the “edit” permission of the approver at this node will be withdrawn, which can only be read.

Regarding permission handling for initiator operations, when withdrawing an approval request, the document owner is returned from the app to the initiator. And the document collaboration permissions of all approvers are withdrawn.

About approver's permission processing:

In case of approval rejection: The current approver revokes document permissions, including edit/permission to views, which is deemed to have removed collaborators. At the same time, the document owner is returned from the application to the initiator.

When transferring approval items to others for approval: Apply the current approver's document permissions to the referred person. If the current approver has permission to view for the document, the referred person will grant permission to view to the document. At the same time, the approver's original permissions are retained.

In the case of adding approvers, that is, when adding other approvers: the document permissions of the current approver are applied to the approver. If the current approver has permission to view for the document, the approver will grant permission to view to the document. At the same time, the original permissions of the approver are retained.

In the case of reducing approvers, that is, when the approver is reduced: revoke the document permissions of the approver whose approval is reduced.

In the case of rollback, that is, when the approval node is rolled back to the previous approval node: The document permissions set for the current approval node are opened for the rollback person. If it is rolled back to initiator the initiator needs to be granted permission to edit.

In the case of copying and sharing, when you copy the approval item to others or share it with others, it is possible to only enable predetermined permissions for the copying or shared person, such as read document permissions.

Automatic deduplicate of approver can also be realized: For scenarios where the same approver needs to approve at different nodes, if the document content changes after approval by the approver, the next approval node needs to be re-approved. For example, it is possible to determine whether the document version has undergone predetermined changes by calling the document version change interface or obtaining document version information, so that when the predetermined change occurs, the corresponding approver can be approved. Or when there is no predetermined change, when the approver at a certain section has seen the corresponding information of the current version, skip the approver to avoid repeated approval.

Above, taking approval as an example, an example explanation has been given for the change of document permissions with service logic and service processes. It can be seen that when an application is associated with a cloud document, the permissions of the cloud document can be processed based on the service processing logic and process of the application. For example, when the predetermined service processing node is reached, the document permissions of the relevant persons of the node are changed. Another example is to revoke the document permissions of the predetermined person after the predetermined service node is processed.

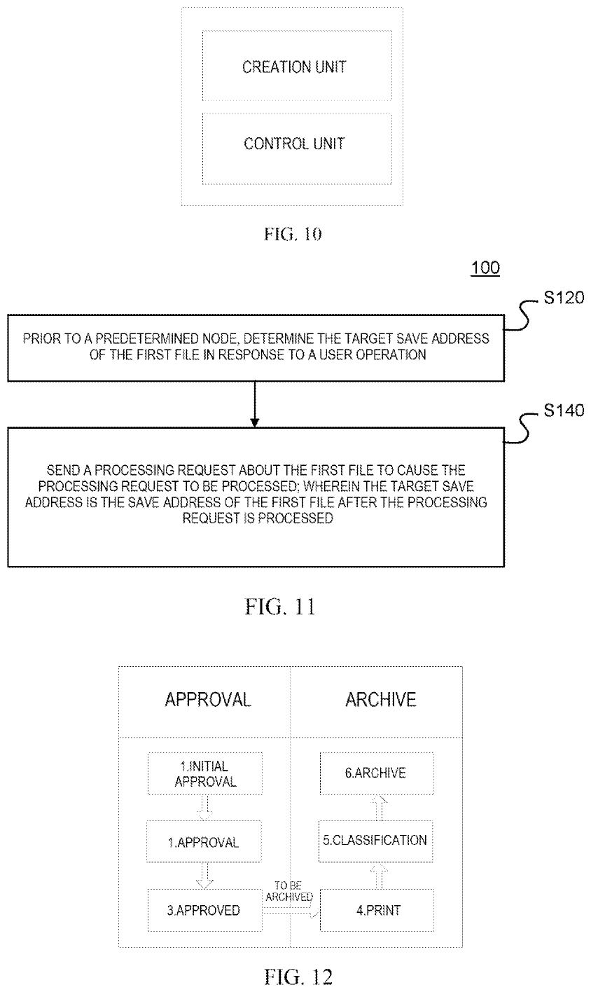

As shown in FIG. 10, the present embodiment also provides an apparatus for information processing, comprising: a creation unit for creating a first processing item having a first online document in response to a first operation event; a control unit configured to trigger a processing flow of the first processing item in response to the second operation event.

According to one or more embodiments of the present disclosure, there is provided an apparatus for information processing, further comprising a setting unit for, in response to the flow creation operation, setting the document processing node of the processing flow and the handler of the service processing node permissions.

According to one or more embodiments of the present disclosure, there is provided an apparatus for information processing, prior to creating a first processing item in response to a first operation event, further comprising: a template creation unit for creating an item template for processing an item having controls for adding an online document in the item template; The first processing item is established based on the item template.

According to one or more embodiments of the present disclosure, there is provided an apparatus for information processing, the Control Unit is further configured to display the first processing item in the control target communication software handler of the node of the processing flow.

According to one or more embodiments of the present disclosure, there is provided an apparatus for information processing having a document display area for displaying the first online document in the display interface of the first processing item, the document display area, the size and/or position of the document display area is adjustable.

According to one or more embodiments of the present disclosure, there is provided an apparatus for information processing, the creator of the first processing item is the owner of the first online document, and after triggering the processing flow of the first processing item, ownership of the first online document is transferred from the creator of the first processing item to the first application; after the processing flow of the first processing item is completed, ownership of the first online document is returned to the creator of the first processing item.

According to one or more embodiments of the present disclosure, there is provided an apparatus for information processing, during the execution of the processing flow, the first online document permission to edit only open the current service processing node of the processing flow has the handler permission to edit; after the end of the processing flow, recover the document permission assigned to the handler of the service processing node.

According to one or more embodiments of the present disclosure, there is provided a method of information processing comprising: before the predetermined processing node corresponding to the processing request for the first file, the target save address of the first file is determined in response to a user operation, so that the first file is saved to the target save address after the processing request is completed.

FIG. 11 shows a flowchart of a method of information processing 100 according to an embodiment of the present disclosure, the method 100 includes:
Step S120: before the predetermined node, in response to user operation, determine the target save address of the first file;
Step S140: send a processing request about the first file to process the processing request; wherein the target save address is the save address of the first file after the processing request is processed.

In some embodiments, in response to a user operation of the predetermined identifier, the display stored in advance one or more levels of file save directory, the user can select a specific target directory location in the file save directory, so that the user can select the directory location to determine the target save address of the first file.

For example, the processing request may be a request for one or more of its users to approve the first file.

In some embodiments, the first file includes but is not limited to documents, images, multimedia electronic files, program files and the like.

In some embodiments, the processing request may include the first file or the link information corresponding to the first file, so as to facilitate the processing request of the handler to obtain the first file, thereby speeding up the processing process.

It should be noted that before the predetermined node, the processing of the request can be completed, for example, when the request is created, before the request is sent, or during the processing of the request.

Preferably, step S120 is executed before the processing request is sent, such as when the processing request is created, so that no additional operation steps are required to set the target storage location of the first file, thereby improving the efficiency of saving files and saving manpower.

The following is an example of document approval. Referring to FIG. 12, the relevant document approval archiving process (manual archiving) includes initiating a document approval request, one or more person approving the document, approving it, printing, classifying, and archiving the document. Similarly, the electronic archiving process also requires special operation steps to electronically archive the document after the approval process is completed, and the archiving efficiency is low, requiring additional manpower. Referring to FIG. 13, according to one or more embodiments of the present disclosure, before initiating approval, relevant person can set that the document to be approved should be saved in a directory in a certain cloud storage space after approval. In this way, when the document to be approved is completed, the system can automatically save the file according to the predefined archiving strategy without special archiving operations, realizing the synchronization of archiving and approving the document, thereby improving the efficiency of approval and archiving and saving manpower.

According to one or more embodiments of the present disclosure, by a predetermined node before, based on the user's operation to determine the target address of the first file is saved, the processing request can be made on the first file is processed, the first file is automatically saved to the target save address, without waiting until the processing of the processing request is completed to save the file by a special file save operation, to achieve synchronization of file storage and processing request processing, thereby improving the efficiency of file processing.

In some embodiments, before performing step S120, in response to the user's operation, it is determined whether to perform a predetermined save the first file after the processing request is processed. For example, the user can set whether to archive the file after approval before initiating file approval. If so, the archive address of the first file can be further set, that is, the target save address.

In some embodiments, the processing request includes information indicating the target save address. In the present embodiment, the processing request on the first file further comprises information indicating the target save address, the first file can be stored to the corresponding target save address according to the instruction information after the processing request is processed.

In some embodiments, if the first file is a document, the method 100 further comprises:

Step S150: After the processing request is processed, the processing information corresponding to the processing request is displayed at a predetermined position in the document.

In some embodiments, the processing information includes, but is not limited to, processing node information, handler information, processing opinion information, processing time information.

The following is an example of document approval. According to one or more embodiments of the present disclosure, after the approval is completed, approval information about the document can be displayed at a predetermined position in the approved document, such as below the title, including but not limited to approval node information, approver information, approval comment information, approval time information, etc., such as “approval node: department approval”, “approver: department manager, Zhang San”, “comment approval: agree”, “approval time: Jan. 1, 2021”, so that subsequent users of the document can easily access the approval information related to the document by opening the document. For example, after the approval is completed, the approval information of the document can be automatically generated in the document through a predetermined API (Application Programming Interface).

In this way, by displaying processing information corresponding to the processing request at a predetermined position within the document after the processing request is processed, it is possible to facilitate subsequent possible review and review of the document or corresponding processing flow, such as enterprise financial review, audit, etc.

In some embodiments, the process information includes link information configured to display the process details information in response to a user's operation. in this way, by displaying the link information only within the document, the content of the document itself is not unduly affected, and it is also convenient for the user to click to view the process details information corresponding to the document. for example, the process details information includes, but is not limited to, process node information, process person information, process opinion information, and process time information.

In some embodiments, the method 100 further comprising: step S101: storing a file save directory in advance; step S120 comprises: in response to a user operation of the file save directory, determining the target save address of the first file.

By way of example, a file storage directory at a cloud server can be created in advance and stored in the client for the user to select a target save address for the first file in the cloud server device from the file storage directory. The file storage directory stored in the client can also be updated in real time or periodically through a predetermined interface, thereby realizing synchronization between the file storage directory of the client and the cloud server.

The following will be described using cloud file approval as an example. According to one or more embodiments of the present disclosure, by using cloud files as carriers for approval items containing files, when users create approvals, they specify specific cloud space archive directories for subsequent cloud files, and set corresponding directory nodes for approval form options, so that after the approval is completed, the cloud files included in the approval items are automatically archived to the corresponding cloud space directory nodes by calling the cloud space archive interface, so as to achieve efficient and fast approval file archiving capabilities.

The traditional method is to judge whether to archive the approval documents and execute the archiving steps only after the approval is completed. This disclosure allows the approver to set whether the approval documents need to be archived and in which directory before the predetermined node in the approval process, such as before the approval is initiated or completed. Because the archive is stored in cloud space, the archived content is not limited to text files, but also supports different forms of electronic information records such as text, charts, audio, and video.

In some embodiments, it is possible to check whether the approval procedure corresponding to the approval file must belong to the file to be archived, if so, for example, if the archive information is not selected, or the approval is not passed, the next step is not allowed, for example, the approval file archive.

In some embodiments, automatic archiving is achieved by establishing an association between the cloud file storage center and the approval program, such as opening a directory interface of the cloud file storage center, calling the directory interface through the approval program, and storing the approval file corresponding to the approval program in a specified directory. Wherein, the directory structure of the cloud file storage center can be set in advance.

In some embodiments, it is possible to check whether the approval procedure corresponding to the approval file must belong to the file to be archived. If so, for example, if the archive information is not selected, or the approval is not passed, the next step is not allowed, for example, the approval file archive.

Further details are provided below, such as the following example:

About the archive directory interface:

In one method, one of the steps to achieve automatic archiving is to pre-set the archive directory interface of the approval file. Through this archive interface, automatic archiving can be carried out according to the archive directory designated by relevant person after the approval is completed. The setting of the archive directory interface first forms a standardized archive information directory, and then exchanges system information between archive directories through relevant interface technologies.

Of course, in other embodiments, it is also possible to create or modify the directory information in the approval process, synchronize the newly created or modified directory information to the cloud file storage center to update the directory structure of the cloud file storage center, so as to facilitate users to update the cloud file directory flexibly in the approval process. In order to avoid users updating the cloud file directory at any time, resulting in non-standard file archiving, predetermined verification rules can also be set, or a predetermined approval entry for directory updates. Only if the new or modified archive directory meets the predetermined verification rules, such new creation and modification are allowed. Alternatively, only by modifying or creating a directory through the approval entry can the archive directory be successfully modified or updated in the cloud file storage center.

About the archive directory:

The archive directory is a directory used to store files, which can be a folder used to store files. The archive directory can include first-level, second-level, third-level directories configured according to enterprise service. The archive interface can save or mount the approval file at a specified location in the archive directory based on the file identifier corresponding to the approval file, such as a token, and the directory information corresponding to the target save address, such as the directory ID.

In some embodiments, the directory information corresponding to the target save address may be included in the approval file or the approval request, the directory information may include the archive directory ID and archive description information that the approval file needs to be archived. Archiving can be achieved by identifying the directory and archive description information in the directory information. For example, the archive description information may include directory information of the archive directory.

Typically, the final determined archive directory needs to be confirmed by the user, in order to ensure the accuracy of the archive, of course, in some embodiments, the confirmation may not be necessary.

The archive directory data structure can be a hierarchical structure such as a tree.

In one embodiment, the first online document can be generated according to the service data associated with the service node, or the content data carried in the first online document can be processed. In the approval scenario, approval information (also referred to as approval-related information) can be generated based on one or more of the approval nodes, approvers, and approval progress-related information in the approval program, and the approval information can be carried in the online document and subsequently archived in the cloud file storage center. Among them, the new online document can be generated, and the approval information can be written in the newly generated online document, or in the predetermined area of the existing online document. The written approval information can be displayed in a predetermined format. In one way, the approval information can be displayed in a predetermined format below the title of the online document, for example, the approval-related information can be displayed in the form of an API link. Through the API link, it is possible to jump to the corresponding approval program or open the approval information details. In one embodiment, the approval document information may be information automatically generated after approval, or with the approval of the corresponding update information can be written in the form of a link through the API under the online document title, saved together in the archive directory. Approval-related information may include: the name of each approval process, the operator the content of the opinion, the approval time and other information. Among them, through the API interface, page information recognition, predetermined field value extraction, etc., to obtain approval-related information from the approval process.

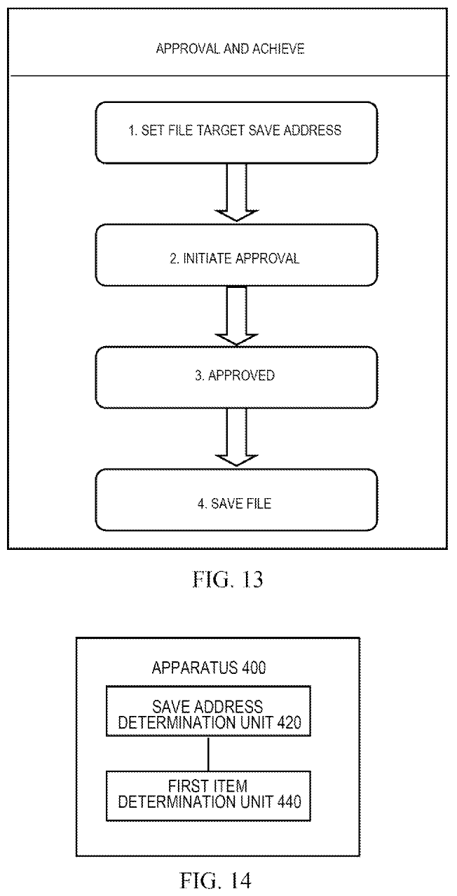

Accordingly, as shown in FIG. 14, there is provided an apparatus for information processing 400 according to an embodiment of the present disclosure, comprising: The save address determination unit 420 configured to determine the target save address of the first file in response to user operations before the predetermined node;

The request sending unit 440 is used to send the processing request about the first file so that the processing request is processed; wherein the target save address is the save address of the first file after the processing request is processed.

In some document processing scenarios (such as enterprise approval scenarios), approval types such as official documents, systems, qualification review, contracts, etc. often rely on different information or file contents as decision-making basis. The approval process involves communication and collaboration among multiple parties, but the approval process itself needs to be rigorous. Therefore, the information or documents under approval should not be modified at will during the approval process, otherwise online cloud documents cannot be used to carry information or files during the approval process. However, when the approval is not passed, the initiator of the process needs to modify the information or files. After the approval is passed, the information or files are based on the enterprise archiving needs and should not be modified again at this time.

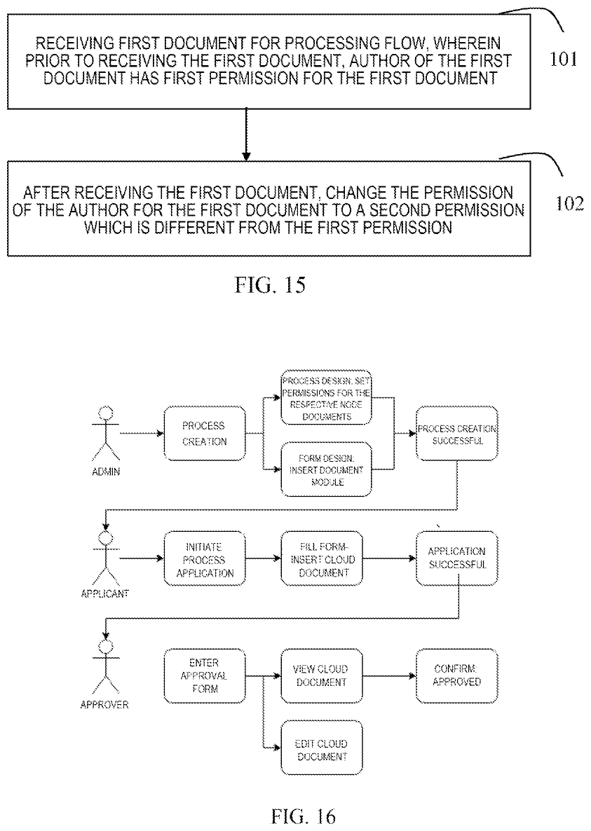

FIG. 15 provides a flow chart of a method of information processing of an embodiment of the present disclosure. The information processing method of the present disclosure may include a step 101 of receiving a first document for processing flow. In some embodiments, the first document is a cloud document or an online document. In some embodiments, the first document is referred to as a first online document. In some embodiments, the processing flow is an approval flow, such as approving bills, contracts, Purchase Requisitions, etc.

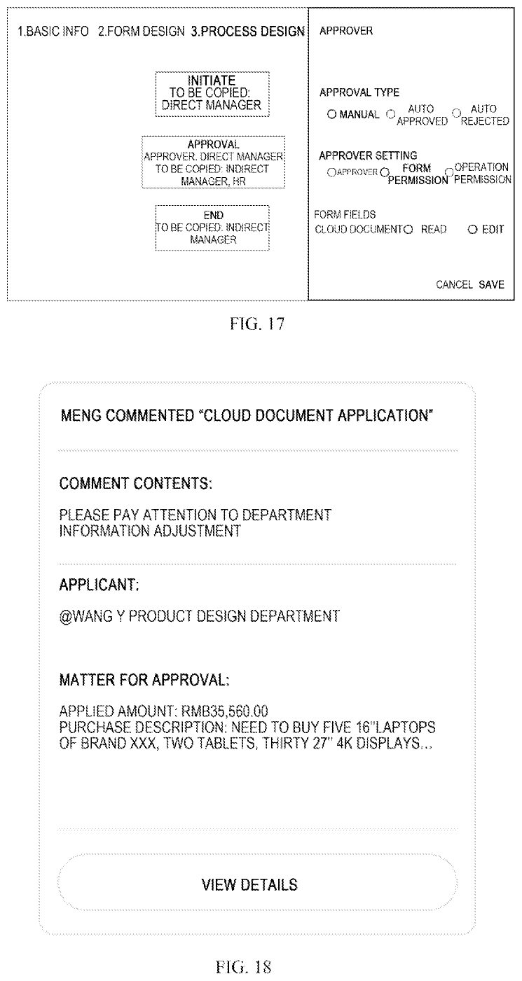

FIG. 16 shows a schematic diagram of the processing flow using the approval process as an example. In some embodiments, as shown in FIG. 16, the administrator first creates the corresponding approval process, designs the process, and sets the document permissions of each node in the approval process. In addition, form design is performed to provide an insert document module. After the process is successfully created, the initiator or applicant of the approval process can initiate an approval process application, fill out the form, and insert the cloud document. After the applicant's application is successful, the approver of each node in the approval process enters the approval form for approval. During the approval process, the approver can usually view and edit the cloud document. After the approver of all nodes confirms that there are no errors, the approval is passed and the approval process ends.

In some embodiments, the author or original editor of the first document has first access to the first document prior to receiving the first document, i.e., prior to successful application by the applicant or initiator of the processing flow.

In some embodiments, the method disclosed herein may further comprise the step of 102, after receiving the first document, the author's access to the first document is changed to a second permission, the second permission is different from the first permission. That is, after entering the processing flow, the system can automatically control the permissions of the first document to ensure efficient collaboration through the first document, on the other hand to ensure rigor in the process flow, to avoid the first document being improperly modified in the process flow.

In some embodiments, the first permission is the permission to read and the permission to edit, and the second permission is the permission to read. The permission to read can only read the first document, and the permission to edit can edit the first document.

In some embodiments, the administrator will need to process cloud documents to join the processing node, so that it can obtain the assigned role of the cloud document. In some embodiments, the administrator can specify that the handler has permission to reads and permission to edit for the document when assigning the role. As shown in FIG. 17, when the administrator is designing the process, he can set the handler and person(s) to be copied at each stage, the processing type, and the corresponding permissions of the handler.

In some embodiments, after receiving the first document, the handler in the node of the processing flow has predetermined permissions on the first document. In the process flow creation process, the permissions of the handler of each node in the processing flow can be set, and once the first document enters the processing flow, the handler of the corresponding node has the corresponding predetermined permissions on the first document. Thus, efficient and unified management of the permissions of the first document in the processing flow is facilitated.

In some embodiments, when the first document fails to pass the processing flow or is returned to the initiator of the processing flow, the author's permission to the first document is changed from the second permission to the first permission, that is, the permission to read and the permission to edit. In some embodiments, the first document is not passed through the processing flow or is returned to the initiator of the processing flow due to the form or substance of the first document being unqualified. When this happens, the author may want to modify the first document to meet the corresponding requirements. In this way, by changing the author's permission to the first document from the second permission to the first permission, the processing flow can be sequentially carried out. After the author completes the modification of the first document, the first document that meets the requirements can be submitted for the next processing flow.

In some embodiments, when a first handler in a node of the processing flow transfers a processing task to another person, the other person has the same permissions on the first document as the first handler had on the first document before the transfer. For example, the first handler is the transferor and the other person is the transferred person. If the first handler has permission to edit on the first document, the other person also has permission to edit on the first document; if the first handler only has reading permissions, the other person also has reading permissions. In this way, the permissions of task processing in the processing flow are handed over or connected in an orderly manner, thereby ensuring rigor in the processing flow.

In some embodiments, when a first handler in a node of the process flow adds a task node to another person, the other person and the first handler have the same permissions for the first document. That is, the person to be added to the task node has the same permissions to the first document as the person to add it. For example, if the first handler has permission to edit for the first document, the other person also has permission to edit to the first document; if the first handler only has permission to reads, the other person also has permission to reads. In this way, the permissions of task processing in the process flow are handed over or connected in an orderly manner, thereby ensuring rigor in the process flow.

In some embodiments, when the task node corresponding to the first handler in the process flow is deleted, the first handler's permission to the first document is withdrawn. When the task node corresponding to the first handler is deleted, the first handler no longer needs to process the first document, and the first handler's permission to the first document is withdrawn, which can avoid unnecessary modifications that the first handler may make to the first document later, thereby ensuring rigor in the process flow.

In some embodiments, when the processing flow proceeds from the current node to the next node, the first handler of the current node changes the permission for the first document from the first permission to the second permission, and the second handler of the next node changes the permission for the first document from the second permission to the first permission. Since the first handler of the current node has finished processing, changing his permission to the first document from the first permission to the second permission, for example, withdrawing the permission to edit, can avoid inappropriate modifications of the first handler in the subsequent processing flow, and can ensure the rigor in the processing flow. In addition, since the processing flow enters the next node, the permission of the second handler of the next node to the first document is changed from the second permission to the first permission, for example, the permission to edit is added, which can also ensure the smooth processing of the second handler.

In some embodiments, when the processing flow returns from the current node to the previous node, the first handler of the previous node changes the permission for the first document from the second permission to the first permission, and the second handler of the current node changes the permission for the first document from the first permission to the second permission. Since the second handler of the current node has finished processing and returned to the previous node, changing its permission to the first document from the first permission to the second permission, for example, withdrawing the permission to edit, can avoid inappropriate modifications by the second handler in the subsequent processing flow, and can ensure the rigor in the processing flow. In addition, because the processing flow enters and returns to the previous node, the permission of the first handler of the previous node to the first document is changed from the second permission to the first permission, for example, the permission to edit is added, and the smooth processing of the first handler can also be ensured, for example, after editing the first document and then entering the next processing flow in order.

In some embodiments, the copied and the shared person only have permission to read and no permission to edit. In some embodiments, the newly assigned user will perform actions on the reassigned pending document.

In some embodiments, the information processing method of the present disclosure further comprises: receiving comment content in the comment area of the first document, and sending a notification message to the initiator and the handler of the processing flow when the comment content is not associated with any person in the comment content. In some embodiments, the comment function is turned on by default in the processing flow, which can help the handler quickly notify the initiator of the processing opinion through the comment function, so that the corresponding person can adjust the content to be processed according to the processing opinion timely (for example, the first document). For example, as shown in FIG. 18, Meng's comment content is “Please pay attention to department information adjustment.”, and there is no @anyone, that is, the comment content is not associated with any specific person. At this time, the notification message shown in FIG. 18 is sent to the initiator and the handler of the processing flow to facilitate the initiator and the handler of the processing flow to view the comment content and process it in a timely manner, which is conducive to improving the efficiency of processing and collaboration.

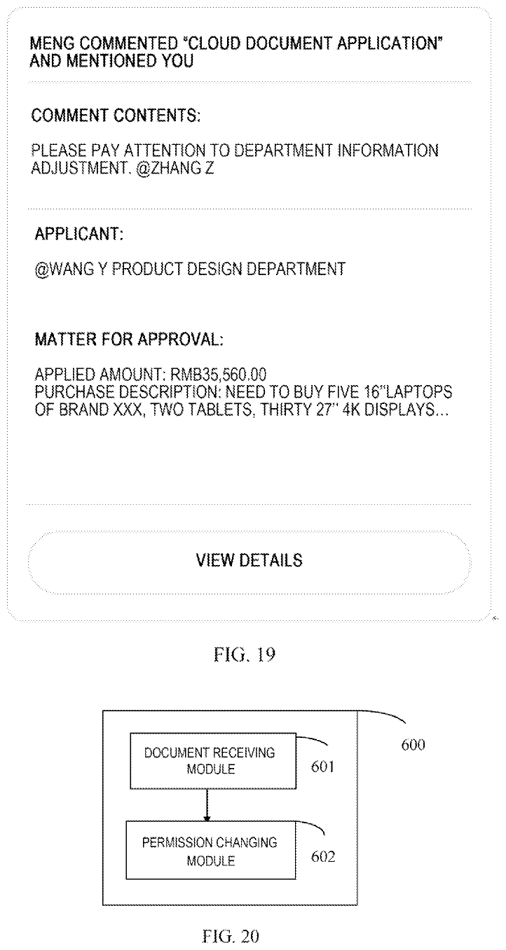

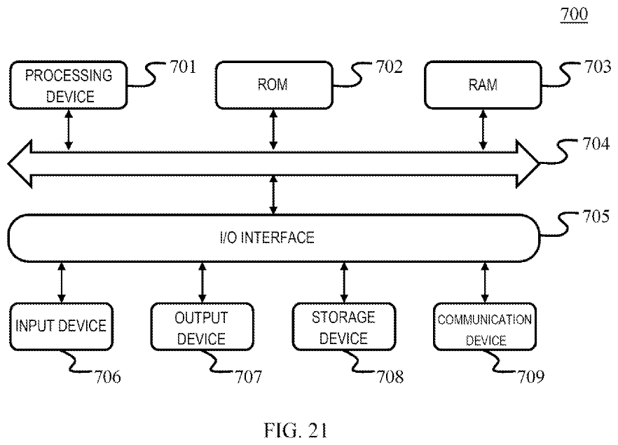

In some embodiments, the information processing method of the present disclosure further comprises: receiving comment content in the comment area of the first document, and when the comment content is associated with the handler of the processing flow, sending a notification message to the initiator of the processing flow and the handler associated with the comment content. For example, as shown in FIG. 19, Meng's comment content is “Please pay attention to departmental information adjustment.”, and he @Zhang Z, that is, the comment content is associated with Zhang Z. When Zhang Z is the handler of the processing flow (e.g., an approver at a certain node), he sends a notification message as shown in FIG. 19 to the initiator and Zhang Z of the processing flow, so that the initiator and Zhang Z of the processing flow can view the comment content in time and process it in a timely manner. In addition, in FIGS. 18 and 19, after the corresponding person clicks “View Details”, he can directly jump to the corresponding document to be processed for processing.

In some embodiments, the information processing method of the present disclosure further comprises: receiving comment content in the comment area of the first document, associating the comment content with a specific person in the comment content, and sending a reminder message when a specific person does not have the permission for the first document, reminding whether to open the readable permission for the first document to a specific person. In some embodiments, for example, as shown in FIG. 19, Meng @Zhang Z in the comment, and Zhang Z does not have permission to the first document, a reminder message is sent at this time to remind whether to open the readable permission for the first document to Zhang Z. Thus, it avoids sending a notification message to the corresponding person that the person cannot view the corresponding content.

In some embodiments, a notification message is sent to a particular person when it is determined to open the permission to read of the first document. Similarly, when the permission to read has been opened to Zhang Z of FIG. 19, a corresponding notification message can be sent to Zhang Z at this time to facilitate the particular person (e.g., Zhang Z) to view the comment content in a timely manner.

The disclosed embodiment also provides an apparatus for information processing 600, which includes a document receiving module 201 and a permission changing module 202. In some embodiments, the document receiving module 201 is configured to receive a first document for processing flow, wherein the author of the first document has a first permission to the first document before receiving the first document. In some embodiments, the permission changing module 202 is configured to change the author's permission to the first document to a second permission after receiving the first document, which is different from the first permission.

It should be understood that the content described about the information processing method also applies to the information processing device 600 used here. For simplicity, it will not be described in detail here.

In some embodiments, the first permission is the permission to read and the permission to edit, and the second permission is the permission to read. In some embodiments, after receiving the first document, the handler in the node of the processing flow has predetermined permissions on the first document. In some embodiments, the author's permissions on the first document are changed from the second permission to the first permission when the first handler in the node of the processing flow transfers the processing task to another person, the other person has the same permissions on the first document as the first handler had before the transfer. In some embodiments, when the first handler in the node of the processing flow adds a task node to another person, the other person and the first handler have the same permissions on the first document. In some embodiments, when the task node corresponding to the first handler in the node of the processing flow is deleted, the first handler's permissions for the first document are withdrawn. In some embodiments, when the processing flow proceeds from the current node to the next node, the first handler of the current node changes the permission for the first document from the first permission to the second permission, and the second handler of the next node changes the permission for the first document from the second permission to the first permission. In some embodiments, when the processing flow returns from the current node to the previous node, the permission of the first handler of the previous node to the first document changes from the second permission to the first permission, and the permission of the second handler of the current node to the first document changes from the first permission to the second permission. In some embodiments, the information processing apparatus further comprises a notification module configured to send a notification message to the initiator and the handler of the processing flow when the comment content is received in the comment area of the first document, and the comment content is not associated with any person in the comment content. In some embodiments, the notification module is also configured to send a notification message to the initiator of the processing flow and the handler associated with the comment content when the comment content is received in the comment area of the first document and the comment content is associated with the handler of the processing flow. In some embodiments, the information processing apparatus further comprises a reminder module configured to receive comment content in the comment area of the first document, the comment content associated with a specific person in the comment content, and a specific person does not have the permission for the first document for a limited time, a reminder message is sent to remind whether the permission to read of the first document is opened to a specific person. In some embodiments, the notification module is further configured to send a notification message to a specific person when it is determined that the permission to read of the first document is opened to a specific person.

Regarding the message sending when the cloud document comment content changes, in some embodiments, when the cloud document comment content changes, the approver can be notified to pay attention to the cloud document content change in time through the robot message sending technology.

### Scenario 1:

When a specific person is mentioned in the cloud document comment content, for example, by using the @symbol to mention a specific person, if the @person is an approval node person, the approval robot can send messages to the approval submitter and the @person. If the @person does not have cloud document permissions or is not a relevant member of the approval node, it can prompt whether to enable the other party (@person) to have permission to read of the cloud document. If so, the document will be enabled to have permission to read, and the cloud document will notify the @person; if the document is not enabled to have permission to read, no notification will be given. The notification can be made in the form of a message card. After clicking the notification to view the details, it is possible to directly jump to the corresponding cloud document approval documentation in the approval application for approval. The content of the notification message can include the comment content, the applicant (also known as the drawer) submitting the approval, the approval reason, etc.

### Scenario 2:

When there is no @person in the content of the cloud document, notifications can be sent to the document submitter and the person to be approved. The notification content can include comments, the applicant submitting the approval (also known as the bill of lading person), the reason for approval, etc. Among them, in Scenario 1, the reasons why it is not sent to the person to be approved include: 1. @is a scene that clearly needs to be replied, so it needs to be sent to the person to be @. 2. Sending it to the bill of lading person at the same time is to inform the document owner, but does not need to disturb other approvers.

In this disclosure, the ability of the cloud document editing switch permission is called by the application in an interface manner, and the deep integration of the cloud document permission and the application is realized, so that the collaboration ability of the cloud document is more suitable for the specific service logic and application scenarios of the application.

When the service status is switched, for example, when the approval flow status is switched, the permission to edit of cloud documents is automatically adjusted. For example, when the permission to edit is turned off during approval, the permission is reopened if the approval is not passed, and after the approval is passed, the permission is turned off for automatic archiving. It is possible to set permissions reasonably to avoid damaging service logic or causing information leakage, etc.

In some embodiments, for applications such as approval with cloud documents, the cloud document comment function can be opened by default during service processing such as approval to achieve better service collaboration such as approval.

Further, the present disclosure also provides a terminal, comprising: at least one memory and at least one processor; wherein the memory for storing program code, the processor for calling the program code stored in the memory to perform the above method.

In addition, the present disclosure also provides a computer storage medium, which stores program code, and the program code is used to execute the above method.

The information processing method and apparatus of the present disclosure have been described based on embodiments and application examples. In addition, the present disclosure also provides a terminal and a storage medium, the following description of these terminals and storage media.

Referring now to FIG. 21, which shows a schematic structural diagram of an electronic device (e.g., a terminal device or server) 700 suitable for implementing the present disclosure embodiment. Terminal devices in the present disclosure may include but are not limited to mobile phones, laptops, digital broadcast receivers, PDAs (personal digital assistants), PADs (tablets), PMPs (portable multimedia players), car terminals (e.g., car navigation terminals), and the like, as well as fixed terminals such as digital TVs, desktop computers, etc. The electronic device shown in FIG. 21 is only one example and should not bring any limitation on the functionality and scope of use of the present disclosure embodiment.

As shown in FIG. 21, electronic device 700 may include processing devices (such as Central Processor graphics processing unit, etc.) 701, which can perform various appropriate actions and processes based on programs stored in read-only memory (ROM) 702 or loaded from storage device 708 into random access memory (RAM) 703. In RAM 703, various programs and data required for the operation of electronic device 700 are also stored. Processing devices 701, ROM 702, and RAM 703 are connected to each other through bus 704. Input/output (I/O) interface 705 is also connected to bus 704.

Typically, the following devices can be connected to the I/O interface 705: input devices 706, including touch screens, touchpads, keyboards, mice, cameras, microphones, accelerometers, gyroscopes, etc.; output devices 707, including liquid crystal displays (LCDs), speakers, vibrators, etc.; storage devices 708, including magnetic tapes, hard disks, etc.; and communication devices 709. Communication devices 709 can allow electronic devices 700 to communicate wirelessly or wirelessly with other devices to exchange data. Although FIG. 21 shows electronic devices 700 with various devices, it should be understood that it is not required to implement or have all of the devices shown. More or fewer devices can be implemented or provided alternatively.

In particular, according to embodiments of the present disclosure, the process described above with reference to the flowchart may be implemented as a computer software program. For example, embodiments of the present disclosure include a computer program product comprising a computer program carried on a computer-readable medium, the computer program comprising program code for performing the method shown in the flowchart. In such embodiments, the computer program may be downloaded and installed from the network through the communication device 709, or installed from the storage device 708, or installed from the ROM 702. When the computer program is executed by the processing device 701, the above-described functions defined in the method of the present disclosure are performed.

It should be noted that the computer-readable medium described above in this disclosure can be a computer-readable signal medium or a computer-readable storage medium or any combination thereof. The computer-readable storage medium can be, for example, but not limited to, an electrical, magnetic, optical, electromagnetic, infrared, or semiconductor system, device, or any combination thereof. More specific examples of computer-readable storage media can include but are not limited to: an electrical connection with one or more wires, a portable computer disk, a hard disk, random access memory (RAM), read-only memory (ROM), erasable programmable read-only memory (EPROM or flash memory), optical fibers, portable compact disk read-only memory (CD-ROM), optical storage devices, magnetic storage devices, or any suitable combination thereof. In this disclosure, a computer-readable storage medium can be any tangible medium containing or storing a program that can be used by or in conjunction with an instruction execution system, device, or device. In this disclosure, a computer-readable signal medium can include a data signal propagated in a baseband or as part of a carrier wave, which carries computer-readable program code. Such propagated data signals can take many forms, including but not limited to electromagnetic signals, optical signals, or any suitable combination thereof. Computer-readable signal media can also be any computer-readable medium other than computer-readable storage media, which can send, propagate, or transmit programs for use by or in conjunction with instruction execution systems, devices, or devices. The program code contained on the computer-readable medium can be transmitted using any suitable medium, including but not limited to: wires, optical cables, RF (radio frequency), etc., or any suitable combination thereof.

In some embodiments, the client and server may communicate using any currently known or future developed network protocol such as HTTP (HyperText Transfer Protocol), and may interconnect with any form or medium of digital data communication (e.g., a communication network). Examples of communication networks include local area networks (“LANs”), wide area networks (“WANs”), the Internet (e.g., the Internet), and end-to-end networks (e.g., ad hoc end-to-end networks), as well as any currently known or future developed networks.

The computer-readable medium can be included in the electronic device, or it can exist separately and not be assembled into the electronic device. The computer-readable medium carries one or more programs, and when the one or more programs are executed by the electronic device, the electronic device performs the method disclosed above.

Computer program code for performing the operations of the present disclosure may be written in one or more programming languages, or combinations thereof, including Object Oriented programming languages such as Java, Smalltalk, C++, and also conventional procedural programming languages such as “C” or similar programming languages. The program code may be executed entirely on the user's computer, partially on the user's computer, as a standalone software package, partially on the user's computer, or entirely on a remote computer or server. In the case of a remote computer, the remote computer may be connected to the user's computer via any type of network, including a local area network (LAN) or a wide area network (WAN), or may be connected to an external computer (e.g., via the Internet using an Internet service provider).

The flowcharts and block diagrams in the accompanying drawings illustrate the architecture, functions, and operations of systems, methods, and computer program products that may be implemented in accordance with various embodiments of the present disclosure. in this regard, each block in the flowchart or block diagram may represent a module, program segment, or portion of code that contains one or more executable instructions for implementing a specified logical function. It should also be noted that in some alternative implementations, the functions marked in the blocks may also occur in a different order than those marked in the figures. For example, two blocks represented in succession may actually be executed substantially in parallel, and they may sometimes be executed in the opposite order, depending on the function involved. It should also be noted that each block in the block diagram and/or flowchart, and combinations of blocks in the block diagram and/or flowchart, may be implemented using a dedicated hardware-based system that performs the specified function or operation, or may be implemented using a combination of dedicated hardware and computer instructions.

Described in the present embodiment relates to the disclosed unit may be implemented by way of software, may be implemented by way of hardware, wherein the name of the unit does not constitute a limitation on the unit itself in some cases.

The functions described above herein may be performed at least in part by one or more hardware logic components. For example, without limitation, example types of hardware logic components that may be used include: field programmable gate arrays (FPGAs), application specific integrated circuits (ASICs), application specific standard products (ASSPs), system-on-chip (SOCs), complex programmable logic devices (CPLDs), and the like.

In the context of this disclosure, machine-readable media can be tangible media that can contain or store programs for use by or in conjunction with instruction execution systems, devices, or devices. Machine-readable media can be machine-readable signal media or machine-readable storage media. Machine-readable media can include, but are not limited to, electronic, magnetic, optical, electromagnetic, infrared, or semiconductor systems, devices, or devices, or any suitable combination thereof. More specific examples of machine-readable storage media may include electrical connections based on one or more wires, portable computer disks, hard disks, random access memory (RAM), read-only memory (ROM), erasable programmable read-only memory (EPROM or flash memory), optical fibers, convenient compact disk read-only memory (CD-ROM), optical storage devices, magnetic storage devices, or any suitable combination thereof.

[Example 1] of the present disclosure provides a method of data processing for an application, comprising: displaying service data in a first display area of a first application display interface; displaying first online document information in a second display area of the first application display interface, the first online document carrying content required for processing the service data; and processing the service data in response to a first operation initiated based on the content carried by the first online document.

[Example 2] of the present disclosure provides a method in combination of [Example 1], wherein displaying the first online document information comprises: in response to an online document addition control being triggered, adding an existing first online document or creating a first online document.

[Example 3] of the present disclosure provides a method in combination of [Example 1], further comprising: in response to a second operation, adding a file required for processing the service data to the first online document.

[Example 4] of the present disclosure provides a method in combination of [Example 1], wherein displaying the first online document information in the second display area of the first application display interface comprises: displaying the first online document in an unfolded state in the second display area, to display content information carried by the first online document.

[Example 5] of the present disclosure provides a method in combination of [Example 1], wherein by carrying a file required for processing the service data by the first online document, an application processing interface contains no additional control other than an online document addition control.

[Example 6] of the present disclosure provides a method in combination of [Example 1], further comprising: associating the first online document with a document archive address to enable automatic archiving of the first online document.

[Example 7] of the present disclosure provides a method in combination of [Example 6], further comprising: archiving the first online document to the associated document archive address at a predetermined time, wherein the predetermined time comprises reaching or completing a predetermined service node of the first application.

[Example 8] of the present disclosure provides a method in combination of [Example 6], wherein associating the first online document with a document archive address comprises: displaying an archive address selection page of a document storage center when the first online document is added to the first application, or displaying an archive address selection page of a document storage center at the predetermined time; and determining the archive address in response to an operation on the archive address selection page.

[Example 9] of the present disclosure provides a method in combination of [Example 6], wherein associating the first online document with a document archive address comprises: determining a first archive address associated with a service data template, and determining the document archive address based on the first archive address, wherein the service data is generated based on the service data template, the service data template associated with the first archive address, the first archive address associated with a target online document, the target online document being an online document associated with data established based on the service data template; and/or associating the first online document with a document archive address comprises: displaying an archive address selection page in response to an operation of adding the first online document in a display interface of the first application, and determining the document archive address based on a selected second archive address.

[Example 10] of the present disclosure provides a method in combination of [Example 1], further comprising: changing a display position and/or a display size of the second display area in response to a third operation.

[Example 11] of the present disclosure provides a method in combination of [Example 10], wherein changing a display position and/or a display size of the second display area in response to a third operation comprises: if a length of the second display area in a first direction is greater than a first predetermined length, in response to a first predetermined operation, adjusting the length of the second display area in the first direction according to the first predetermined operation.

[Example 12] of the present disclosure provides a method in combination of [Example 11], wherein adjusting the length of the second display area in the first direction according to the first predetermined operation comprises: if the length of the second display area in the first direction is not greater than a second predetermined length, ceasing to adjust the length of the second display area in the first direction according to the first predetermined operation, wherein the first predetermined length is greater than the second predetermined length.

[Example 13] of the present disclosure provides a method in combination of [Example 10], wherein changing a display position and/or a display size of the second display area in response to a third operation comprises: in response to a control identification being located on a first or second side of the second display area, changing a style of the control identification, and after changing the style of the control identification, changing the position of the first or second side according to an operation of the control identification to change the size of the second display area.

[Example 14] of the present disclosure provides a method in combination of [Example 13], wherein, in response to a control identification being located on a first or second side of the second display area, changing a style of the control identification, comprises: after the second display area is selected, in response to the control identification being located on the first or second side of the second display area, changing the style of the control identification.

[Example 15] of the present disclosure provides a method in combination of [Example 10], wherein an adjustment frequency of the size or position of the second display area is not greater than a first frequency threshold; or if the adjustment frequency of the size or position of the second display area exceeds a second frequency threshold, the display interface is not refreshed.

[Example 16] of the present disclosure provides a method in combination of [Example 10], wherein the second display area has a folded state and an unfolded state, and the second display area is switchable between the folded state and the unfolded state.

[Example 17] of the present disclosure provides a method in combination of [Example 16], wherein while the document display area is in the unfolded state, the content carried by the first online document is displayed; or while the document display area is in the folded state, the content carried by the first online document is hidden, and abridged information of the first online document is displayed.

[Example 18] of the present disclosure provides a method in combination of [Example 16], wherein the second display area has an associated control, if the second display area is in the folded state, the control is used to unfold the second display area after being triggered; or if the second display area is in the unfolded state, the control is used to fold the second display area after being triggered.

[Example 19] of the present disclosure provides a method in combination of [Example 18], wherein the control is fixed at a target position of the display interface; and/or positioning a display interface to the second display area after the control is triggered.

[Example 20] of the present disclosure provides a method in combination of [Example 10], wherein the second display region has a predetermined size range; and changing the display size of the second display area in response to the third operation comprises: determining a target display size of the second display area according to the third operation; if the target display size is greater than a maximum value of the size range, setting the display size of the second display area to the maximum value of the size range; or if the target display size is less than a minimum value of the predetermined size range, setting the display size of the second display area set to the minimum value of the size range.

[Example 21] of the present disclosure provides a method in combination of [Example 1], wherein a display size of the document display area is determined by: determining a reference size according to a data amount of content data carried by the first online document; if the reference size is within a predetermined size range, setting the display size of the document display area according to the reference size; and if the reference size is larger than the maximum value of the size range, setting the display size of the document display area according to a maximum value of the size range.

[Example 22] of the present disclosure provides a method in combination of [Example 10], further comprising at least one of the following: the content carried by the first online document is updated as the service data evolves; the content carried by the first online document comprises service flow information of the service data and/or content information of the service data; the content carried by the first online document comprises data to be referenced by evolvement of the service flow of the service data; or the content carried by the first online document comprises link information that displays a predetermined interface of the first application after being triggered.

[Example 23] of the present disclosure provides an apparatus method for data processing for an application, comprising: a display unit configured to display service data in a first display area of a first application display interface and to display first online document information in a second display area of the first application display interface, the first online document carrying content required for processing the service data; and a processing unit configured to process the service data in response to a first operation initiated based on the content carried by the first online document.

[Example 24] of the present disclosure provides a terminal comprising: at least one memory and at least one processor; wherein the at least one memory configured to store program code, and the at least one processor is configured to call the program code stored in the at least one memory to execute the method of any of [Example 1] to [Example 22].

[Example 25] of the present disclosure provides a computer-readable storage medium storing program code, the program code, when executed by a processor, causing the processor to perform the method of any of [Example 1] to [Example 22].

The technical features in the above examples can also be combined in other ways without contradiction.

According to one or more embodiments of the present disclosure, there is provided a method of information processing comprising: creating a first processing item having a first online document in response to a first operation event; triggering a processing flow of the first processing item in response to the second operation event.

According to one or more embodiments of the present disclosure, there is provided a method of information processing, in response to a first operation event, before creating a first processing item, further comprising: in response to a flow creation operation, setting the service processing node of the processing flow and document permissions of the handler of the service processing node.

According to one or more embodiments of the present disclosure, there is provided a method of information processing, prior to creating a first processing item in response to a first operation event, further comprising: creating an item template for processing an item having a control for adding an online document in the item template; the first processing item is established based on the item template.

According to one or more embodiments of the present disclosure, there is provided a method of information processing, further comprising: displaying the first processing item in a control of the target communication software of the handler of the node of the processing flow.

According to one or more embodiments of the present disclosure, there is provided a method of information processing having a document display area for displaying the first online document in a display interface of the first processing item, the document display area, the size and/or position of the document display area is adjustable.

According to one or more embodiments of the present disclosure, there is provided a method of information processing, the creator of the first processing item is the owner of the first online document, and after triggering the processing flow of the first processing item, ownership of the first online document is transferred from the creator of the first processing item to the first application; after the processing flow of the first processing item is completed, ownership of the first online document is returned to the creator of the first processing item.

According to one or more embodiments of the present disclosure, there is provided a method of information processing in which, during execution of the processing flow, the permission to edit of the first online document is only open to a handler with permission to edit in a current service processing node of the processing flow; withdrawing the document permission assigned to the handler of the service processing node after the processing flow is completed.

According to one or more embodiments of the present disclosure, there is provided a method of information processing, the information processing method comprising: receiving a first document for processing flow, wherein, prior to receiving the first document, the author of the first document has a first permission for the first document; after receiving the first document, the permission of the author for the first document is changed from the first permission to a second permission which is different from the first permission.

According to one or more embodiments of the present disclosure, the first permission is a permission to read and permission to edit, the second permission is a permission to read.

According to one or more embodiments of the present disclosure, after receiving the first document, a handler the processing node in the processing flow has a first permission for the first document.

According to one or more embodiments of the present disclosure, when the first document does not pass the process flow or is returned to the process flow initiator, the author's permission for the first document is changed from the second permission to the first permission.

According to one or more embodiments of the present disclosure, when a first handler in a node of the processing flow transfers the processing task to another person, the other person has the same permission for the first document as the first handler had for the first document before the transfer.

According to one or more embodiments of the present disclosure, when a first processing node in the processing flow adds a task node to another person, the other person and the first handler have the same permission for the first document.

According to one or more embodiments of the present disclosure, when the node of the processing flow corresponding to the first handler task node is deleted, the first handler's permission for the first document is withdrawn.

According to one or more embodiments of the present disclosure, when the processing flow proceeds from the current node to the next node, the permission for the first document of the first handler of the current node is changed from the first permission to the second permission, and the permission for the first document of the second handler of the next node is changed from the second permission to the first permission.

According to one or more embodiments of the present disclosure, when the processing flow returns from the current node to the previous node, the permission for the first document of the first handler of the previous node is changed from the second permission to the first permission, and the permission for the first document of the second handler of the current node is changed from the first permission to the second permission.

According to one or more embodiments of the present disclosure, further comprising: receiving comment content in the comment area of the first document, and the comment content is not associated with any person in the comment content, sending a notification message to the processing flow initiator and handler.

According to one or more embodiments of the present disclosure, further comprising: receiving comment content in the comment section of the first document, and the comment content associated with the processing flow of the handler in the comment content, sending a notification message to the processing flow initiator and the handler associated with the comment content.

According to one or more embodiments of the present disclosure, further comprising: receiving comment content in the comment area of the first document, the comment content in the comment content associated with a particular person, and the particular person when the first document does not have the right to limit, a reminder message is sent to remind whether to open the permission to read for the first document to the particular person.

According to one or more embodiments of the present disclosure, upon determining to open the permission to read for the first document to a particular person, send a notification message to the particular person.

According to one or more embodiments of the present disclosure, there is provided an apparatus for information processing, the information processing apparatus comprising: a document receiving module configured to receive a first document for processing flow, wherein, prior to receiving the first document, the author of the first document has a first permission for the first document; permission change module configured to, after receiving the first document, change the permission for the first document of the author to a second permission which is different from the first permission.

According to one or more embodiments of the present disclosure, there is provided a method of information processing, comprising: prior to the processing request on a first file corresponding to a predetermined processing node, in response to a user operation, determining a first file target save address, so that the first file after the processing request is completed, is saved to the target save address.

According to one or more embodiments of the present disclosure, there is provided a method of information processing comprising: before the predetermined node, in response to user operations, determine the target save address of the first file; sending the processing request regarding the first file so that the processing request is processed; wherein the target save address is the save address of the first file after the processing request is processed.

According to one or more embodiments of the present disclosure, the processing request includes address information of the target save address.

According to one or more embodiments of the present disclosure, if the first file is a document, the information processing method further comprising: after the processing request is processed, the display at a predetermined position within the document processing information corresponding to the request.

According to one or more embodiments of the present disclosure, the processing information includes link information, the link information is configured to be responsive to a user operation display processing details information.

According to one or more embodiments of the present disclosure, the processing details information includes at least one of the following: processing node information, handler information, processing opinion information, processing time information.

According to one or more embodiments of the present disclosure, the information processing method further comprising: storing a file save directory in advance; in response to a user operation, determining the target save address of the first file, comprising: in response to a user operation of the file save directory, determining the target save address of the first file.

According to one or more embodiments of the present disclosure, there is provided a method of information processing, characterized by comprising: a determination unit for determining a target save address of the first file in response to a user operation before any node corresponding to a processing request for the first file, so that the first file is saved to the target save address after the processing request is completed.

According to one or more embodiments of the present disclosure, there is provided an apparatus for information processing comprising: a save address determination unit for determining a target save address of the first file in response to a user operation before a predetermined node; a request sending unit for sending a processing request about the first file so that the processing request is processed; wherein the target save address is the save address of the first file after the processing request is processed.

According to one or more embodiments of the present disclosure, if the first file is a document, the information processing apparatus further comprising: a processing information display unit for processing after the processing request is processed, the predetermined position within the document display processing information corresponding to the processing request.

According to one or more embodiments of the present disclosure, the information processing apparatus further comprising: a directory storage unit for storing a file save directory in advance; in response to a user operation, determining the target save address of the first file, comprising: in response to a user operation of the file save directory, determining the target save address of the first file.

According to one or more embodiments of the present disclosure, there is provided an electronic device comprising: at least one memory and at least one processor; wherein the memory for storing program code, the processor for calling the program code stored in the memory to cause the electronic device to perform a method of providing information processing according to one or more embodiments of the present disclosure.

According to one or more embodiments of the present disclosure, there is provided a non-transitory computer storage medium, the non-transitory computer storage medium stores program code, the program code is executed by a computer device, so that the computer device performs a method of providing information processing according to one or more embodiments of the present disclosure.

The above description is only the preferred embodiment of the present disclosure and an explanation of the technical principles used. Those skilled in the art should understand that the scope of the disclosure involved in this disclosure is not limited to the specific combination of the technical features of the above technical solutions, but should also cover other technical solutions formed by any combination of the above technical features or equivalent features without departing from the above disclosure concept. For example, the technical solutions formed by replacing the above features with (but not limited to) technical features with similar functions disclosed in this disclosure.

In addition, although the operations are depicted in a specific order, this should not be understood as requiring these operations to be performed in the specific order shown or in sequential order. Under certain circumstances, multitasking and parallel processing may be advantageous. Similarly, although several specific implementation details are included in the above discussion, these should not be construed as limiting the scope of the present disclosure. Certain features described in the context of individual embodiments may also be implemented in combination in a single embodiment. Conversely, various features described in the context of a single embodiment may also be implemented in multiple embodiments individually or in any suitable sub combination.

Although the subject matter has been described in language specific to structural features and/or methodological logical acts, it should be understood that the subject matter defined in the appended claims is not necessarily limited to the particular features or acts described above. Rather, the particular features and acts described above are merely example forms of implementation of the claims.

I/we claim:

1. A method of data processing for an application, comprising:
displaying service data in a first display area of a first application display interface;
displaying first online document in a second display area of the first application display interface, the first online document information carrying content required for processing the service data; and
processing the service data in response to a first operation initiated based on the content carried by the first online document.

2. The method of claim 1, wherein displaying the first online document information comprises:
in response to an online document addition control being triggered, adding an existing first online document or creating a first online document.

3. The method of claim 1, further comprising:
in response to a second operation, adding a file required for processing the service data to the first online document.

4. The method of claim 1, wherein displaying the first online document information in the second display area of the first application display interface comprises:
displaying the first online document in an unfolded state in the second display area, to display content information carried by the first online document.

5. The method of claim 1, wherein by carrying a file required for processing the service data by the first online document, an application processing interface contains no additional control other than an online document addition control.

6. The method of claim 1, further comprising:
associating the first online document with a document archive address to enable automatic archiving of the first online document.

7. The method of claim 6, further comprising at least one of:
archiving the first online document to the associated document archive address at a predetermined time, wherein the predetermined time comprises reaching or completing a predetermined service node of the first application,
or, wherein associating the first online document with a document archive address comprises:
displaying an archive address selection page of a document storage center when the first online document is added to the first application, or displaying an archive address selection page of a document storage center at the predetermined time; and
determining the archive address in response to an operation on the archive address selection page,
or, wherein associating the first online document with a document archive address comprises at least one of:
determining a first archive address associated with a service data template, and determining the document archive address based on the first archive address, wherein the service data is generated based on the service data template, the service data template associated with the first archive address, the first archive address associated with a target online document, the target online document being an online document associated with data established based on the service data template; or
displaying an archive address selection page in response to an operation of adding the first online document in a display interface of the first application, and determining the document archive address based on a selected second archive address.

8. The method of claim 1, further comprising:
changing a display position and/or a display size of the second display area in response to a third operation.

9. The method of claim 8, wherein changing a display position and/or a display size of the second display area in response to a third operation comprises:
if a length of the second display area in a first direction is greater than a first predetermined length, in response to a first predetermined operation, adjusting the length of the second display area in the first direction according to the first predetermined operation.

10. The method of claim 9, wherein adjusting the length of the second display area in the first direction according to the first predetermined operation comprises:
if the length of the second display area in the first direction is not greater than a second predetermined length, ceasing to adjust the length of the second display area in the first direction according to the first predetermined operation, wherein the first predetermined length is greater than the second predetermined length.

11. The method of claim 8, wherein changing a display position and/or a display size of the second display area in response to a third operation comprises:
in response to a control identification being located on a first or second side of the second display area, changing a style of the control identification, and after changing the style of the control identification, changing the position of the first or second side according to an operation of the control identification to change the size of the second display area.

12. The method of claim 11, wherein, in response to a control identification being located on a first or second side of the second display area, changing a style of the control identification, comprises:
after the second display area is selected, in response to the control identification being located on the first or second side of the second display area, changing the style of the control identification.

13. The method of claim 8, wherein
an adjustment frequency of the size or position of the second display area is not greater than a first frequency threshold; or
if the adjustment frequency of the size or position of the second display area exceeds a second frequency threshold, the display interface is not refreshed,
or, wherein the second display region has a predetermined size range;
and changing the display size of the second display area in response to the third operation comprises:
determining a target display size of the second display area according to the third operation;
if the target display size is greater than a maximum value of the size range, setting the display size of the second display area to the maximum value of the size range; or
if the target display size is less than a minimum value of the predetermined size range, setting the display size of the second display area set to the minimum value of the size range,
or, the method further comprising at least one of the following:
the content carried by the first online document is updated as the service data evolves;
the content carried by the first online document comprises service flow information of the service data and/or content information of the service data;
the content carried by the first online document comprises data to be referenced by evolvement of the service flow of the service data; or
the content carried by the first online document comprises link information that displays a predetermined interface of the first application after being triggered.

14. The method of claim 8, wherein the second display area has a folded state and an unfolded state, and the second display area is switchable between the folded state and the unfolded state.

15. The method of claim 14, wherein
while the document display area is in the unfolded state, the content carried by the first online document is displayed; or
while the document display area is in the folded state, the content carried by the first online document is hidden, and abridged information of the first online document is displayed.

16. The method of claim 14, wherein
the second display area has an associated control,
if the second display area is in the folded state, the control is used to unfold the second display area after being triggered; or
if the second display area is in the unfolded state, the control is used to fold the second display area after being triggered.

17. The method of claim 16, wherein
the control is fixed at a target position of the display interface; and/or
positioning a display interface to the second display area after the control is triggered.

18. The method of claim 1, wherein a display size of the document display area is determined by:
determining a reference size according to a data amount of content data carried by the first online document;
if the reference size is within a predetermined size range, setting the display size of the document display area according to the reference size; and
if the reference size is larger than the maximum value of the size range, setting the display size of the document display area according to a maximum value of the size range.

19. A terminal comprising:
at least one memory and at least one processor;
wherein the at least one memory configured to store program code, and the at least one processor is configured to call the program code stored in the at least one memory to execute acts comprising:
displaying service data in a first display area of a first application display interface;
displaying first online document in a second display area of the first application display interface, the first online document information carrying content required for processing the service data; and
processing the service data in response to a first operation initiated based on the content carried by the first online document.

20. A non-transitory computer-readable storage medium storing program code, the program code, when executed by a processor, causing the processor to perform acts comprising:
displaying service data in a first display area of a first application display interface;
displaying first online document in a second display area of the first application display interface, the first online document information carrying content required for processing the service data; and
processing the service data in response to a first operation initiated based on the content carried by the first online document.
